(19) United States
(12) Patent Application Publication
(10) Pub. No.: US 2026/0054295 A1
(43) Pub. Date: Feb. 26, 2026

(54) TREATING CHEMISTRY DISTRIBUTION SYSTEM

(71) Applicant: WHIRLPOOL CORPORATION, BENTON HARBOR, MI (US)

(72) Inventors: ANDREW C. CARMICHAEL, MILWAUKEE, WI (US); CHRISTOPHER D. CULLEN, STEVENSVILLE, MI (US); MEGAN C. DADO, BENTON HARBOR, MI (US); YU J. LIU, SAINT JOSEPH, MI (US); JOHN G. OPFER, ROCHESTER, MI (US); EMILY J. PHILLIPS, SAINT JOSEPH, MI (US); JOEL M. SELLS, WATERVLIET, MI (US); VIVEK SINGH, PUNE (IN); RICHARD LEE HAMMOND, MATTAWAN, MI (US); JOSEPH JOHN KEHRER, BENTON HARBOR, MI (US); CHANDLER A. LONGLEY, BENTON HARBOR, MI (US); ELLIOTT V. STOWE, STEVENSVILLE, MI (US)

(21) Appl. No.: 19/298,318

(22) Filed: Aug. 13, 2025

Related U.S. Application Data
(60) Provisional application No. 63/686,951, filed on Aug. 26, 2024.
(60) Provisional application No. 63/816,918, filed on Jun. 3, 2025.

(51) Int. Cl. B08B 3/08

(52) U.S. Cl. CPC B08B 3/08

(57) ABSTRACT

A treating chemistry distribution system for a plurality of treating chemistry devices. The treating chemistry distribution system has a treating chemistry hub, a treating chemistry manifold, and a water line. The treating chemistry hub has a set of treating chemistry modules. The set of treating chemistry modules houses a plurality of treating chemistry reservoirs

### CROSS-REFERENCE TO RELATED APPLICATIONS

This application claims priority to and the benefit of U.S. Provisional Application No. 63/686,951, filed Aug. 26, 2024, and also claims priority to and the benefit of U.S. Provisional Patent Application No. 63/816,918, filed Jun. 3, 2025, both of which are incorporated herein by reference in their entirety.

### TECHNICAL FIELD

The description generally relates to a method and a system utilizing a treating chemistry distribution system.

### BACKGROUND

Contemporary household devices include devices or appliances configured to be used within a household to at least one of wash, clean, cook, process, brew, distribute, refrigerate, or freeze items within or otherwise fed through the household device. Contemporary household devices can include household devices such as, but not limited to, laundry treating appliances, dishwashers, ranges, ovens, garbage disposals, countertop appliances (e.g., a coffee machine, air fryer, slow cooker, etc.), microwaves, refrigerators, freezers, or the like. Contemporary household devices can include other household items such as, but not limited to, mops, wet vacuums (“wet-vacs”), faucets, sinks, soap dispensers, or the like.

### BRIEF DESCRIPTION

In one aspect, the disclosure relates to a cartridge assembly for use in a treating chemistry distribution system for a plurality of treating chemistry devices wherein at least a portion of the treating chemistry distribution system is located within a structure defining at least one environment, the treating chemistry distribution system comprising a treating chemistry hub having a set of treating chemistry modules housing a plurality of treating chemistry reservoirs, a treating chemistry manifold having a set of supply lines independently fluidly coupling the plurality of treating chemistry reservoirs to the plurality of treating chemistry devices, and a water line fluidly having a water line inlet selectively coupled to a water supply and a first water supply line outlet fluidly coupled to a first treating chemistry device of the plurality of treating chemistry devices, wherein at least a first supply line of the set of supply lines is fluidly coupled to the water line and the first supply line of the set of supply lines is configured to provide a treating chemistry from at least one treating chemistry reservoir of the plurality of treating chemistry reservoirs to the first treating chemistry device via the water line.

### BRIEF DESCRIPTION OF THE DRAWINGS

### In the Drawings:

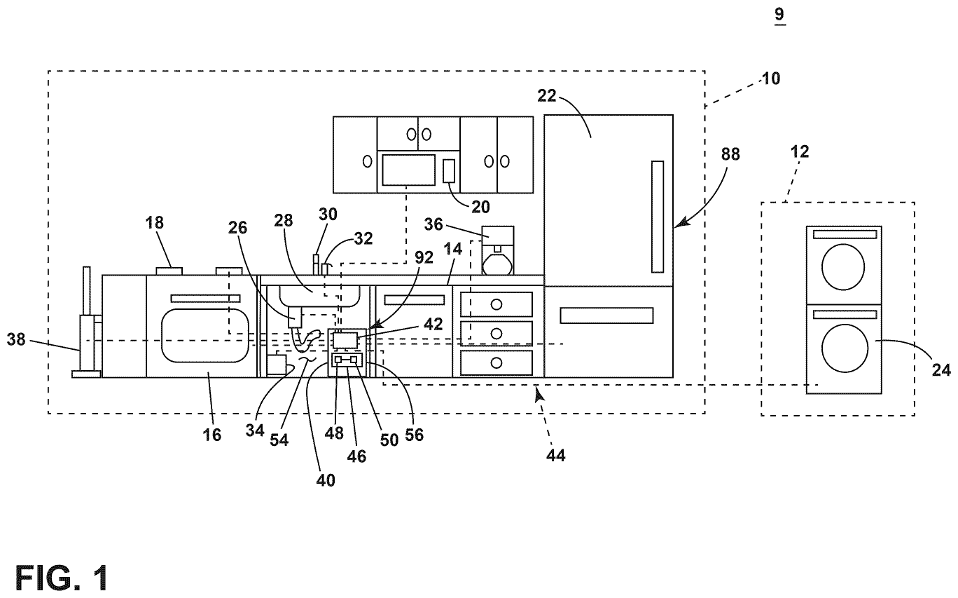

FIG. 1 is a schematic view of a structure including a first environment and a second environment including a set of household devices and a treating chemistry distribution system in accordance with various aspects described herein.

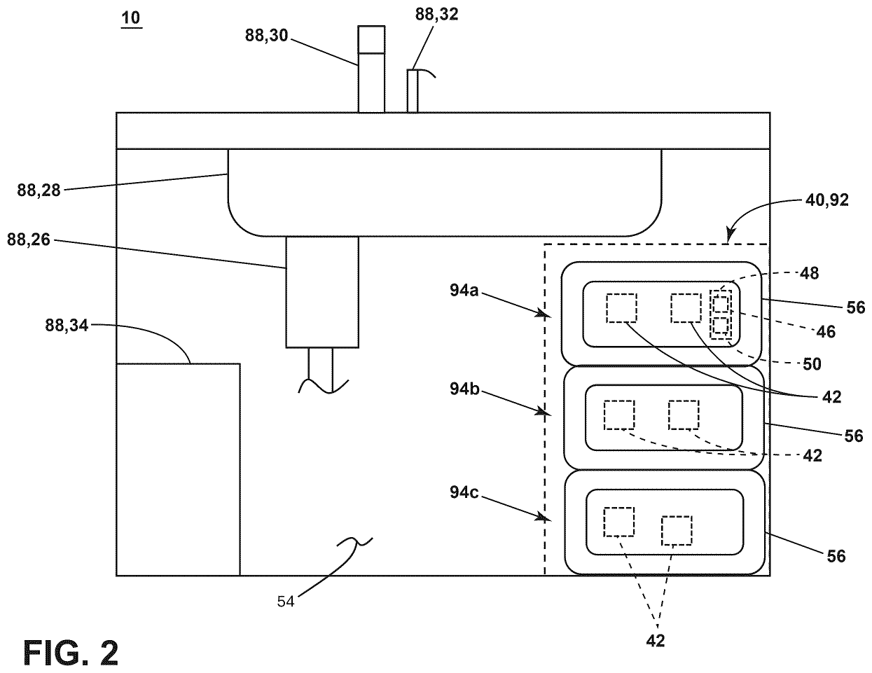

FIG. 2 is a schematic view of a portion of the first environment including a portion of the treating chemistry distribution system of FIG. 1, further comprising a treating chemistry hub having a first treating chemistry module, a second treating chemistry module, and a third treating chemistry module in accordance with various aspects described herein.

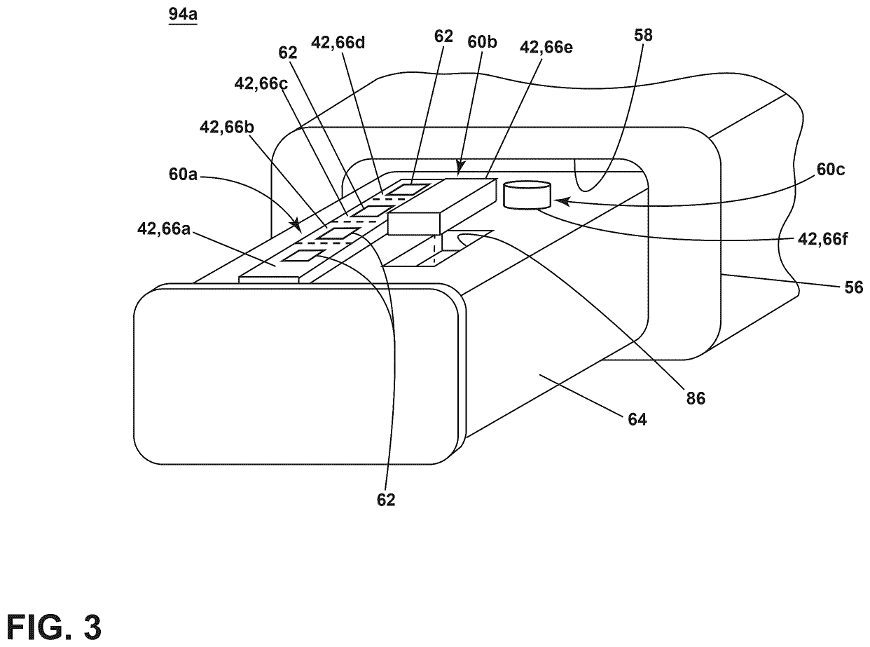

FIG. 3 is a schematic perspective view of the first treating chemistry module of FIG. 2, further illustrating a housing and a set of drawers in accordance with various aspects described herein.

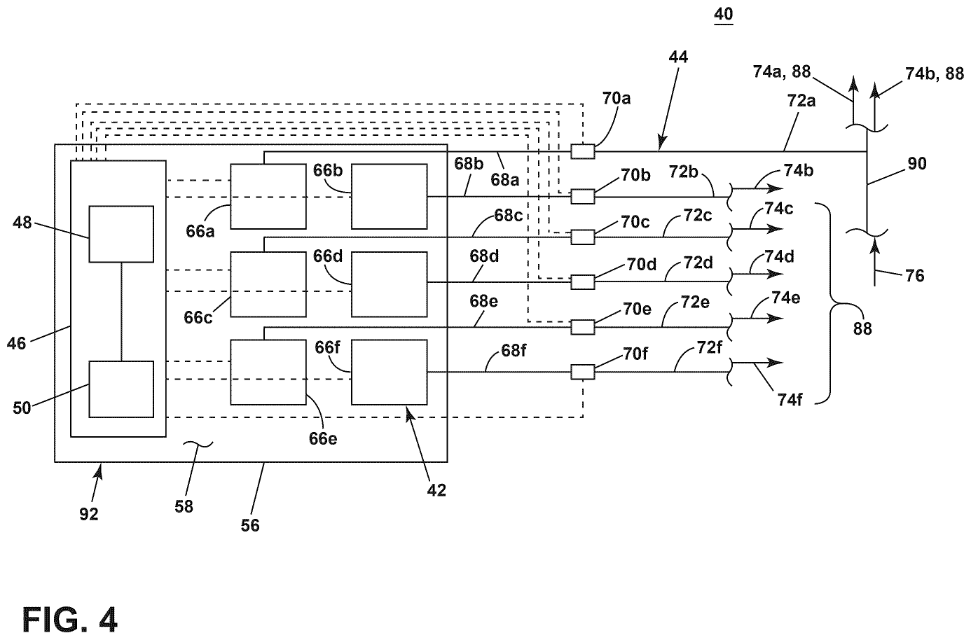

FIG. 4 is a schematic diagram of the treating chemistry distribution system of FIG. 1, further illustrating a treating chemistry manifold of the treating chemistry distribution system in accordance with various aspects described herein.

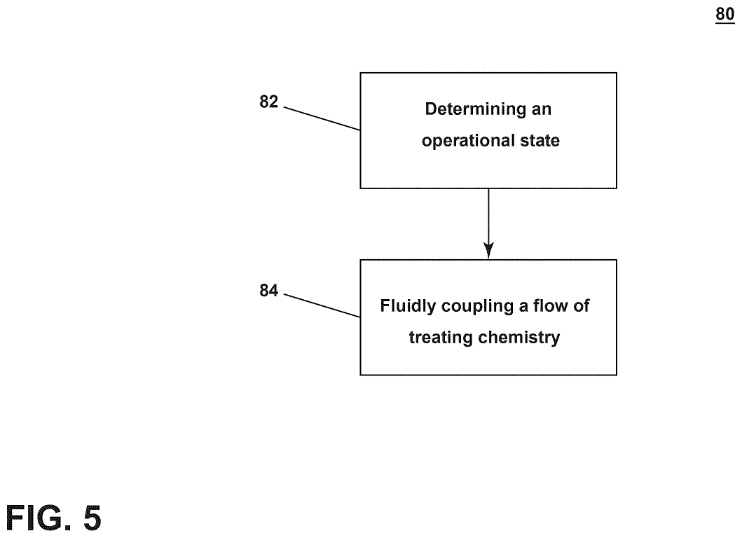

FIG. 5 is a flowchart diagram illustrating a method of utilizing the treating chemistry distribution system of FIG. 1 in accordance with various aspects described herein.

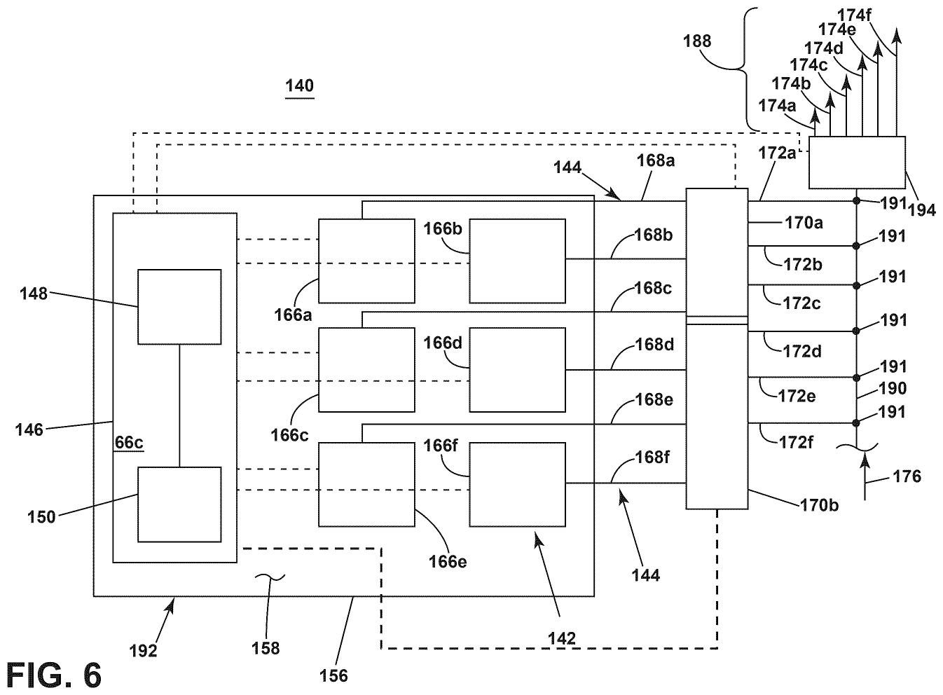

FIG. 6 is a schematic diagram of an exemplary treating chemistry distribution system suitable for use as the treating chemistry distribution system of FIG. 1, further illustrating a treating chemistry manifold, a first flow controller and a second flow controller of the treating chemistry distribution system in accordance with various aspects described herein.

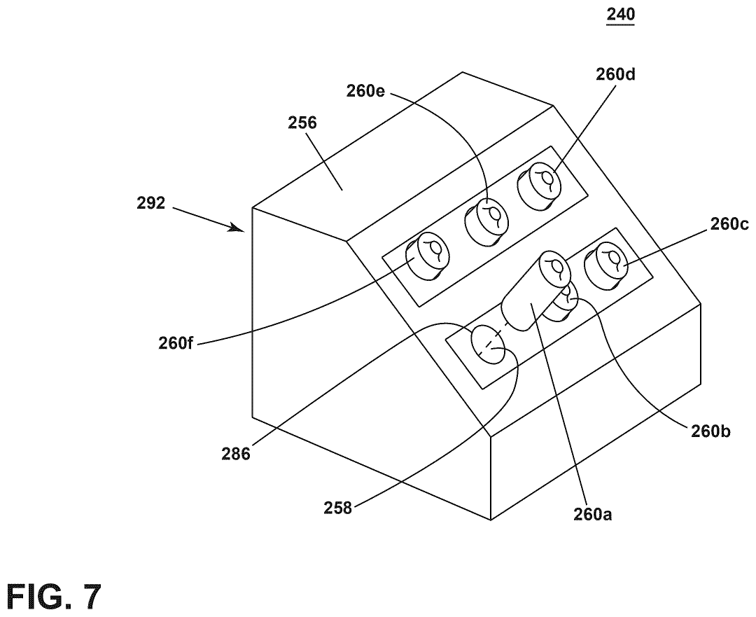

FIG. 7 is a schematic perspective view of a portion of an exemplary treating chemistry distribution system suitable for use as the treating chemistry distribution system of FIG. 1, further illustrating a plurality of cartridges received within a housing of the treating chemistry distribution system in accordance with various aspects described herein.

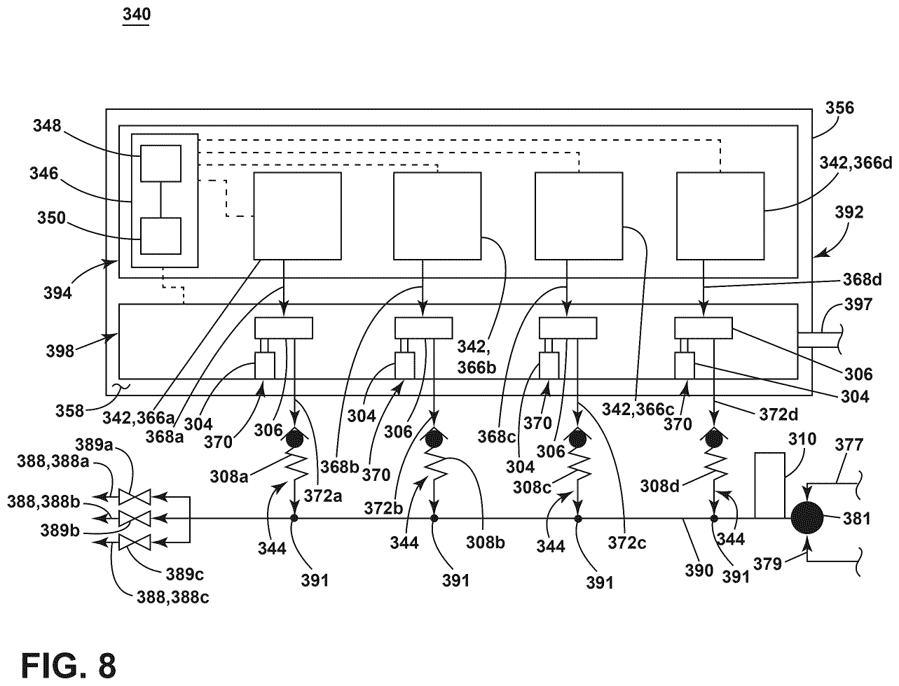

FIG. 8 is a schematic diagram of an exemplary treating chemistry distribution system suitable for use as the treating chemistry distribution system of FIG. 1, further illustrating a treating chemistry hub having a treating chemistry module and a distribution module in accordance with various aspects described herein.

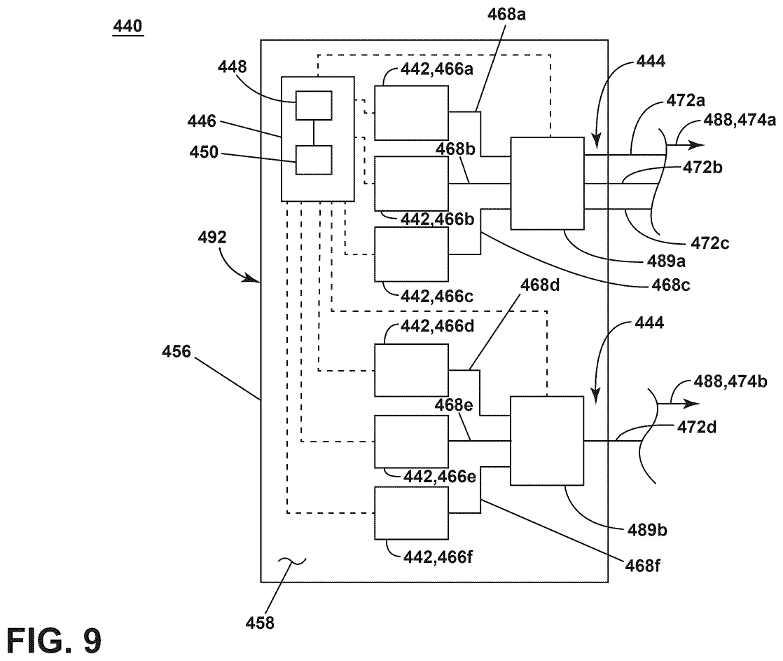

FIG. 9 is a schematic diagram of an exemplary treating chemistry distribution system suitable for use as the treating chemistry distribution system of FIG. 1, further illustrating a first distribution valve leading to a first set of household devices and a second distribution valve leading to a second set of household devices in accordance with various aspects described herein.

### DETAILED DESCRIPTION

Some household devices, such as dishwashers, mops, wet-vacs, laundry treating appliances, etc., utilize a cleaning matter (e.g., fluids, solids, foams, steams, etc.) during operation of the household device to clean articles within or along the household device. Other household devices, such as coffee brewers, microwaves, ovens, garbage disposals, etc., utilize a cleaner fluid to clean the household device itself. It will be appreciated that dishwashers and laundry treating appliances can further use cleaners to clean the dishwasher or laundry treating appliances, respectively. The cleaning matter and the cleaners used during operation of or cleaning of the household device will hereinafter be referred to as treating chemistry. As used herein, “treating chemistry” or iterations thereof refers to a cleaning agent (liquid, gas or solid) that is used to at least one of either clean the household device that the treating chemistry is applied to or within, clean articles within or along the household device, or a combination thereof.

Each household device is adapted to receive at least one respective treating chemistry of a set of treating chemistries. Each treating chemistry of the set of treating chemistries is housed within a respective capsule or a respective container. The respective capsules or respective containers of the set of treating chemistries are normally stored within or near an environment containing the household devices. In some environments, such as a household, it will be appreciated that a plurality of household devices can be included. At least two household devices of the plurality of household devices are adapted to receive differing treating chemistries of the set of treating chemistries. As such, a plurality of treating chemistries can be required for the operation of or cleaning of the plurality of household devices. As each treating chemistry of the set of treating chemistries has a respective capsule or a respective container stored within or near the environment, a footprint required to store the set of treating chemistries increases with each household device that requires a specific treating chemistry.

Further, it is possible that a user may forgo cleaning of or otherwise forget to load or otherwise apply a treating chemistry within the household device during use of or cleaning of the household device. Not cleaning the household device can reduce the lifespan of or efficiency of the household device. Not loading or otherwise applying the treating chemistry to a household device that requires the treating chemistry for use of the household device will cause the household device not to operate as intended.

Aspects of this disclosure are directed towards a treating chemistry distribution system. The treating chemistry distribution system is used to distribute a plurality of treating chemistries to a plurality of household devices within a network of household devices. The chemistry distribution system includes a chemistry hub and a treating chemistry manifold. The chemistry hub includes a plurality of treating chemistry reservoirs. Each treating chemistry reservoir of the plurality of treating chemistry reservoirs is adapted to hold a respective treating chemistry. The treating chemistry manifold distributes the treating chemistry from the plurality of treating chemistry reservoirs to the plurality of household devices.

The treating chemistry distribution system automatically distributes treating chemistry from the plurality of treating chemistry reservoirs to the appropriate household device of the plurality of household devices within the network. The automatic distribution of the treating chemistry is done based on an operational state of the household device. The treating chemistry distribution system reduces the footprint required for the plurality of treating chemistries by consolidating and effectively packaging the plurality of treating chemistries. The treating chemistry distribution system creates a user-friendly approach to operating and/or cleaning the plurality of household devices. While described in terms of the treating chemistry distribution system being used for the plurality of household devices within the network, it will be appreciated that the treating chemistry distribution system has general applicability to other devices that utilize at least one treating chemistry such as, but not limited to, commercial devices or residential devices such as those found in factories, restaurants, hotels, houses, apartments, retailers, or the like. The term “treating chemistry devices” will hereinafter be used to generally refer to devices configured to receive at least one treating chemistry. The treating chemistry device can be found in either a commercial environment (e.g., a commercial device) or a residential environment (e.g., a household device).

As used herein, the terms “first,” “second,” “third,” or the like can be used interchangeably to distinguish one component from another and are not intended to signify location or importance of the individual components. In addition, the singular forms “a,” “an,” and “the” include plural references unless the context clearly dictates otherwise. Furthermore, as used herein, the term “set” or a “set” of elements can be any number of elements, including only one.

Here and throughout the specification and claims, range limitations are combined, and interchanged. Such ranges are identified and include all the sub-ranges contained therein unless context or language indicates otherwise. For example, all ranges disclosed herein are inclusive of the endpoints, and the endpoints are independently combinable with each other.

All directional references (e.g., radial, axial, proximal, distal, upper, lower, upward, downward, left, right, lateral, front, back, top, bottom, above, below, vertical, horizontal, clockwise, counterclockwise, upstream, downstream, forward, aft, etc.) are only used for identification purposes to aid the reader's understanding of the present disclosure, and do not create limitations, particularly as to the position, orientation, or use of aspects of the disclosure described herein. Connection references (e.g., attached, coupled, secured, fastened, connected, and joined) are to be construed broadly and can include intermediate members between a collection of elements and relative movement between elements unless otherwise indicated. As such, connection references do not necessarily infer that two elements are directly connected and in fixed relation to one another. The exemplary drawings are for purposes of illustration only and the dimensions, positions, order, and relative sizes reflected in the drawings attached hereto can vary.

As used herein, the term “single dose of treating chemistry”, and variations thereof, refers to an amount of treating chemistry sufficient for one cycle or cleaning of the appliance or device and the term “multiple doses of treating chemistry”, and variations thereof, refers to an amount of treating chemistry sufficient for multiple cycles or cleanings of the appliance or device.

Additionally, as used herein, a “controller” or “controller module” can include a component configured or adapted to provide instruction, control, operation, or any form of communication for operable components to effect the operation thereof. A controller module can include any known processor, microcontroller, or logic device, including, but not limited to: field programmable gate arrays (FPGA), an application specific integrated circuit (ASIC), a proportional controller (P), a proportional integral controller (PI), a proportional derivative controller (PD), a proportional integral derivative controller (PID controller), a hardware-accelerated logic controller (e.g. for encoding, decoding, transcoding, etc.), or the like, or a combination thereof. Non-limiting examples of a controller module can be configured or adapted to run, operate, or otherwise execute program code to effect operational or functional outcomes, including carrying out various methods, functionality, processing tasks, calculations, comparisons, sensing or measuring of values, or the like, to enable or achieve the technical operations or operations described herein. The operation or functional outcomes can be based on one or more inputs, stored data values, sensed or measured values, true or false indications, or the like. While “program code” is described, non-limiting examples of operable or executable instruction sets can include routines, programs, objects, components, data structures, algorithms, etc., that have the technical effect of performing particular tasks or implement particular abstract data types.

FIG. 1 is a schematic view of a structure 9 including at least one environment. The structure 9, by way of non-limiting example, includes a first environment 10 and a second environment 12. The structure 9 is any suitable structure forming at least the first environment 10 and the second environment 12. It will be appreciated that the structure is a singular, unitary structure. As a non-limiting example, the structure 9 can be a house and the first environment 10 and the second environment 12 can each be rooms within the house. The first environment 10 is separated from the second environment 12 by, for example, a wall, a door, a floor, or a combination thereof of the structure 9. As a non-limiting example, the first environment 10 can be a kitchen while the second environment 12 can be a laundry room. While two environments are illustrated, it will be appreciated that the structure 9 can include any number of one or more environments.

The structure 9 houses a set of treating chemistry devices 88 and a treating chemistry distribution system 40. The treating chemistry distribution system 40 is fluidly couplable with the set of treating chemistry devices 88.

The set of treating chemistry devices 88 include any suitable treating chemistry device or device. As a non-limiting example, the set of treating chemistry devices 88 can include a dishwasher 14, an oven 16, a range 18, a microwave 20, a refrigerator 22, a laundry treating appliance 24, a garbage disposal 26, a sink 28, a faucet 30, a soap dispenser 32, a water heater 34, a countertop appliance 36, and a moveable treating chemistry device 38. The laundry treating appliance 24 can be provided within the second environment 12, while the dishwasher 14, the oven 16, the range 18, the microwave 20, the refrigerator 22, the garbage disposal 26, the sink 28, the faucet 30, the soap dispenser 32, the water heater 34, the countertop appliance 36, and the moveable treating chemistry device 38 are located within the first environment 10.

The laundry treating appliance 24 can be any suitable laundry treating appliance. In the illustrated example, the laundry treating appliance 24 is at least one of a washer, a dryer, both a washer and a dryer, or a combination washer/dryer. While the illustrated laundry treating appliance 24 has a horizontal axis, the network is not limited to implementations in a horizontal axis laundry treating appliance. Depending on the implementation, a vertical axis appliance; a tumbling or stationary refreshing/revitalizing machine; an extractor; or a non-aqueous washing apparatus; can all be suitable environments to include in the network as described herein as further non-limiting examples.

The countertop appliance 36 is any suitable small appliance adapted to be placed along a surface or countertop of the first environment 10. As a non-limiting example, the countertop appliance 36 can be, but is not limited to, a coffee brewer, a slow cooker, a toaster, a convection oven, an espresso machine, or the like. The moveable treating chemistry device 38 is any suitable device that is moveable within or from the environment that the moveable treating chemistry device 38 is stored within. The moveable treating chemistry device 38 can be, but is not limited to, a wet-vac, a mop, a bucket, an autonomous vacuum, or the like. It will be appreciated that the set of treating chemistry devices 88 can include any other suitable treating chemistry device.

The treating chemistry distribution system 40 includes a treating chemistry hub 92 and a treating chemistry manifold 44. The treating chemistry hub 92 includes a plurality of treating chemistry reservoirs 42. Each treating chemistry reservoir 42 holds a volume of treating chemistry. The treating chemistry is any suitable liquid, solid, or gas that is used to clean items within at least one treating chemistry device of the set of treating chemistry devices 88, clean at least one treating chemistry device of the set of treating chemistry devices 88, or a combination thereof. The treating chemistry can include, but is not limited to, a soap, a detergent, a cleaning solution, a cleaning concentrate, washing aids including oxidizers, and additives, such as fabric softeners, sanitizers, de-wrinklers, and chemicals for imparting desired properties to the fabric, including for example, stain resistance, water repellency, fragrance (e.g., perfumes), insect repellency, brighteners, whitening agents, builders, and UV protection, water treating fluid, bleach, enzymes, septic treatments, drain treatments, natural additives or bacteria, anti-spotting agents, disinfectant, or the like.

The treating chemistry hub 92 is located within any suitable environment of the structure 9. As a non-limiting example, the treating chemistry hub 92 can be located within the first environment 10. As a non-limiting example, the treating chemistry hub 92 can be located within an under-sink cabinet interior 54 of the first environment 10. It will be appreciated, however, that the treating chemistry hub 92 can be located in the first environment 10, the second environment 12, or within any other suitable environment. As a non-limiting example, the chemistry hub 92 can be located within an environment free of the set of treating chemistry devices 88.

The treating chemistry manifold 44 fluidly couples the treating chemistry hub 92 to the set of treating chemistry devices 88. It will be appreciated that the treating chemistry manifold 44 independently fluidly couples each treating chemistry reservoir of the plurality of the treating chemistry reservoirs 42 to at least one treating chemistry device of the set of treating chemistry devices 88. As used herein, the phrase “independent fluidly couples” or iterations thereof refers to a selective or controllable fluid coupling between one or more treating chemistry reservoir of the plurality of the treating chemistry reservoirs 42 with one or more treating chemistry device of the set of treating chemistry devices 88. While illustrated in phantom lines, it will be appreciated that the treating chemistry manifold 44 takes various forms. As a non-limiting example, the treating chemistry manifold 44 can be made up of a series of tubes, ducts, channels, conduits, or a combination thereof. By way of non-limiting example, the treating chemistry manifold 44 extends between the plurality of treating chemistry reservoirs 42 and the set of treating chemistry devices 88 to fluidly couple the plurality of treating chemistry reservoirs 42 to the set of treating chemistry devices 88. The treating chemistry manifold 44 can extend between environments. As a non-limiting example, the treating chemistry manifold 44 can extend from the treating chemistry hub 92 in the first environment 10 to the laundry treating appliance 24 in the second environment 12.

The treating chemistry distribution system 40 includes a controller module 46. The controller module 46 can be used to selectively, operably control certain portions of the treating chemistry distribution system 40. As a non-limiting example, the controller module 46 can be used to selectively, operably control a flow of treating chemistry from the plurality of treating chemistry reservoirs 42 to the set of treating chemistry devices 88. The controller module 46 includes a processor 48 and a memory 50. The memory 50 is defined as an internal storage for various aspects of the treating chemistry distribution system 40. For example, the memory 50 can store code, executable instructions, commands, instructions, authorization keys, specialized data keys, passwords, or the like. For example, the memory 50 can store an operation of or a function of the set of treating chemistry devices 88. The memory 50 can be RAM, ROM, flash memory, or one or more different types of portable electronic memory, such as discs, DVDs, CD-ROMs, etc., or any suitable combination of these types of memory. The memory 50 can be a cloud-based memory such that the controller module 46 has access to the memory 50 but the memory 50 is not physically stored on the controller module 46. The processor 48 can be defined as a portion of the controller module 46 which can receive an input, perform calculations, and output executable data. The processor 48 can be a microprocessor.

The controller module 46 is located along any suitable portion of the treating chemistry distribution system 40. As a non-limiting example, the controller module 46 is located within the treating chemistry hub 92.

It will be appreciated that the treating chemistry distribution system 40 can include other additional, non-illustrated components. As a non-limiting example, the treating chemistry distribution system 40 can include a user interface that is communicatively coupled to the controller module 46. The user interface can be, for example, a table, a computer, a screen, a knob, a switch, a keypad, a phone, or the like. It is contemplated that a user of the treating chemistry distribution system 40 can utilize the user interface to provide an input to the controller module 46. The input can include, for example, instructions to the controller module 46 for which treating chemistry within the plurality of treating chemistry reservoirs 42 should be fed to which treating chemistry device of the set of treating chemistry devices 88 at a given time. As a non-limiting example, the user can utilize the user interface to input a schedule for the control of or cleaning of the set of treating chemistry devices 88. As a non-limiting example, the user can input the schedule such that that controller module 46 automatically sends appropriate treating chemistry to one or more treating chemistry devices of the set of treating chemistry devices 88 to operate or clean the one or more treating chemistry devices when the user wants the one or more treating chemistry devices to be cleaned or operated.

FIG. 2 is a schematic view of a portion of the first environment 10 including a portion of the treating chemistry distribution system 40 of FIG. 1. The first environment 10 includes the under-sink cabinet interior 54 and at least a portion of the set of treating chemistry devices 88. Specifically, the set of treating chemistry devices 88 in the illustrated portion of the first environment 10 include the garbage disposal 26, the sink 28, the faucet 30, the soap dispenser 32, and the water heater 34. The portion of the treating chemistry distribution system 40 illustrated is the chemistry hub 92.

The chemistry hub 92 is located within the under-sink cabinet interior 54. It will be appreciated that the illustrated location of the chemistry hub 92 is a non-limiting example of a location of the chemistry hub 92. It will be appreciated that the chemistry hub 92 can be located within various portions of the first environment 10, the second environment 12 (FIG. 1), any other environment of the structure 9 (FIG. 1), or a combination thereof.

The chemistry hub 92 includes a set of treating chemistry modules. The set of treating chemistry modules include any number of one or more treating chemistry modules. As a non-limiting example, the chemistry hub 92 includes a first treating chemistry module 94a, a second treating chemistry module 94b, and a third treating chemistry module 94c. A collective of the treating chemistry modules of the set of treating chemistry modules (e.g., the first treating chemistry module 94a, the second treating chemistry module 94b, and the third treating chemistry module 94c collectively) form the chemistry hub 92. The treating chemistry hub 92, therefore, is illustrated in phantom lines.

Each treating chemistry module of the set of treating chemistry modules is defined by a body of a set of bodies 56. Each body of the set of bodies 56 houses a respective portion of the plurality of treating chemistry reservoirs 42. Each body of the set of bodies 56 for each treating chemistry module of the set of treating chemistry modules is formed as separate, discrete bodies. Put another way, each body of the set of bodies 56 of the first treating chemistry module 94a is a separate, discrete body from the body of the set of bodies 56 of the second treating chemistry module 94b. Each body of the set of bodies 56 is configured to house a respective subset of the treating chemistry reservoirs of the plurality of treating chemistry reservoirs 42.

In relation to one another, the set of treating chemistry modules can be stacked, as illustrated. As a non-limiting example, the body of the set of bodies 56 of the second treating chemistry module 94b is stacked on top of the body of the set of bodies 56 of the third treating chemistry module 94c. The body of the set of bodies 56 of the first treating chemistry module 94a is stacked on top of the body of set of bodies 56 of the second treating chemistry module 94b. It will be appreciated, however, that the set of treating chemistry modules can be arranged in various contacting or non-contacting formations. It will be appreciated that the formation that the set of treating chemistry modules are provided in can be dependent on the location that the treating chemistry hub 92 is located.

Each body of the set of bodies 56 of each treating chemistry module of the set of treating chemistry modules can take any suitable formation. As a non-limiting example, each body of the set of bodies 56 of each treating chemistry module of the set of treating chemistry modules can be rectangular with rounded corners (as illustrated). Alternatively, each body of the set of bodies 56 can be at least one of, rectangular with or without rounded edges, trapezoidal with or without rounded edges, hexagonal with or without rounded edges, triangular with or without rounded edges, circular, ovular, or the like. Each body of the set of bodies 56 can include additional non-illustrated portions. As a non-limiting example, at least one body of the set of bodies 56 can be formed with or otherwise include a retainer that interfaces with another body 56 of the set of treating chemistry modules. The retainer can couple the at least one body of the set of bodies 56 of two or more terrain chemistry modules of the set of treating chemistry modules together. The retainer can be, for example, a hook, a peg, a channel, a divot, a magnet, or the like formed along the at least one body of the set of bodies 56 of the at least one treating chemistry module. As a non-limiting example, at least one body of the set of bodies 56 of the first treating chemistry module 94a can include a peg that interfaces with a channel of the at least one body of the set of bodies 56 to the second treating chemistry module 94b to couple the first treating chemistry module 94a to the second treating chemistry module 94b.

Each treating chemistry module of the set of treating chemistry modules includes at least one treating chemistry reservoir of the plurality of treating chemistry reservoirs 42, illustrated in phantom lines. It will be appreciated that each treating chemistry module of the set of treating chemistry modules can have an equal number of treating chemistry reservoirs of the plurality of treating chemistry reservoirs 42. As a non-limiting example, each of the first treating chemistry module 94a, the second treating chemistry module 94b, and the third treating chemistry module 94c each include two treating chemistry reservoirs of the plurality of treating chemistry reservoirs 42. Alternatively, at least two treating chemistry modules of the set of treating chemistry modules can include a non-equal number of treating chemistry reservoirs of the plurality of treating chemistry reservoirs 42.

The controller module 46, illustrated in phantom lines, includes the processor 48 and the memory 50. At least one treating chemistry module of the set of treating chemistry modules can include the controller module 46. As a non-limiting example, a singular one of the treating chemistry module of the set of treating chemistry modules can include the controller module 46. It is contemplated that the controller module 46 of the treating chemistry module (e.g., the first treating chemistry module 94a) can communicate with the other treating chemistry modules of the set of treating chemistry modules (e.g. the second treating chemistry module 94b, and the third treating chemistry module 94c) to selectively control dispensing of the treating chemistry from the plurality of treating chemistry reservoirs 42. Put another way, the singular one of the treating chemistry module can be defined as a master treating chemistry module including the controller module, while the other treating chemistry modules of the set of treating chemistry modules are defined as follower treating chemistry modules formed without a respective controller module 46. Alternatively, each treating chemistry module of the set of treating chemistry modules can include a respective controller module 46.

FIG. 3 is schematic perspective view of a portion of the treating chemistry distribution system 40 of FIG. 1, specifically, the first treating chemistry module 94a. The first treating chemistry module 94a includes a body of the set of bodies 56 and at least a portion of the plurality of treating chemistry reservoirs 42. Each body of the set of bodies 56 defines an interior 58. The plurality of treating chemistry reservoirs 42 are receivable within the interior 58. While described in terms of the first treating chemistry module 94a, it will be appreciated that the aspects described herein can be applied to any treating chemistry module of the set of treating chemistry modules.

Each body of the set of bodies 56 can be any suitable shape. As a non-limiting example, each body of the set of bodies 56 is a rectangular prism with rounded edges. Alternatively, at least one body of the set of bodies 56 can be the rectangular prism with or without rounded edges, a triangular prism with our without rounded edges, a trapezoidal prism with our without rounded edges, a hexagonal prism with our without rounded edges, a cylinder, or the like.

Each body of the set of bodies 56 can include a housing closure 64. The housing closure 64 is defined as any suitable body of a respective body of the set of bodies 56 that provides selective access to the interior 58. As illustrated the housing closure 64 is in an opened position. The opened position is defined as a positioning of the housing closure 64 where various portions of the chemistry hub 92 stored within the interior 58 (e.g., the plurality of treating chemistry reservoirs 42, as discussed below) are accessible from an exterior of the respective body of the set of bodies 56. In a closed position, the various portions of the chemistry hub 92 stored within the interior 58 are non-accessible from the exterior of the respective body of the set of bodies 56. The housing closure 64 can be, as a non-limiting example, a drawer that provides selective access to the interior 58, as illustrated. The drawer is slidably received within the interior 58. Alternatively, the housing closure 64 can be various other bodies such as, but not limited to, a latch, a hatch, a door, or the like.

The treating chemistry hub 92 may include a treating chemistry meter (not shown) operably coupled to the plurality of treating chemistry reservoirs including any cartridge to control the dosing of the treating chemistry. The treating chemistry meter may be a pump, a valve, a flow meter, or any other suitable metering device fluidly coupling the reservoir to the manifold. More specifically the cartridge can be fluidly coupled to any portion of the drawer or reservoir through the treating chemistry meter. The treating chemistry meter may dose treating chemistry multiple times during a single cycle of operation. Dosing of the treating chemistry does not need to be done all at one time. For example, smaller amounts of treating chemistry, equal to a full single dose, may be dispensed by the treating chemistry meter at separate times throughout the cycle of operation. Further, multiple full doses may be dispensed during the cycle of operation.

The housing closure 64 is selectively receivable within the interior 58. Put another way, the housing closure 64 is adapted to store at least one treating chemistry reservoir of the plurality of treating chemistry reservoirs 42. While a singular housing closure 64 is illustrated, it will be appreciated that the first treating chemistry module 94a includes any number of one or more housing closures 64.

In one non-limiting example, each body of the set of bodies 56 can include a set of receivers 86 adapted to accept or otherwise accommodate for a body defining at least one treating chemistry reservoir of the plurality of treating chemistry reservoirs 42. The use of the set of receivers 86 will be described in further detail below.

While not illustrated, each closure of the set of closures 64 can include various structure(s) configured to distribute the treating chemistry within the plurality of treating chemistry reservoirs 42 into the treating chemistry manifold 44. As a non-limiting example, the set of closures 64 can include structure similar to bulk dispensing systems utilized in laundry treating appliances such as those described in U.S. Pat. No. 11,035,070 granted Jun. 15, 2021.

As a non-limiting example, the first treating chemistry module 94a includes a first treating chemistry reservoir 66a, a second treating chemistry reservoir 66b, a third treating chemistry reservoir 66c, a fourth treating chemistry reservoir 66d, a fifth treating chemistry reservoir 66e, and a sixth treating chemistry reservoir 66f. Each treating chemistry reservoir of the plurality of treating chemistry reservoirs 42 is housed within a set of treating chemistry cartridges including a first treating chemistry cartridge 60a, a second treating chemistry cartridge 60b, and a third treating chemistry cartridge 60c. Each treating chemistry cartridge of the set of treating chemistry cartridges 60a, 60b, 60c is defined as a physical container or vessel adapted to accept and store a respective volume of treating chemistry. Put another way, each treating chemistry cartridge of the set of treating chemistry cartridges 60a, 60b, 60c defines a housing for at least one treating chemistry reservoir of the plurality of treating chemistry reservoirs 42.

Each treating chemistry cartridge of the set of treating chemistry cartridges 60a, 60b, 60c holds or otherwise defines at least one treating chemistry reservoir of the plurality of treating chemistry reservoirs 42. As a non-limiting example, a first treating chemistry cartridge 60a defines the first through fourth treating chemistry reservoirs 66a-d. For purposes of illustration, the delineation between the first through fourth treating chemistry reservoirs 66a-d are shown in phantom lines. As a non-limiting example, a second treating chemistry cartridge 60b defines the fifth treating chemistry reservoir 66e. As a non-limiting example, a third treating chemistry cartridge 60c defines the sixth treating chemistry reservoir 66f. The set of treating chemistry cartridges 60a, 60b, 60c include any number of one or more treating chemistry cartridges. It will be appreciated that each treating chemistry cartridge of the set of treating chemistry cartridges 60a, 60b, 60c holds or otherwise defines any number of one or more treating chemistry reservoirs of the plurality of treating chemistry reservoirs 42.

It will be appreciated that at least one treating chemistry cartridge of the set of treating chemistry cartridges 60a, 60b, 60c can be formed with (e.g., integrally) a respective body of the set of bodies 56. As a non-limiting example, the first treating chemistry cartridge 60a and the third treating chemistry cartridge 60c can be integrally formed with the respective body of the set of bodies 56. Alternatively, one or more treating chemistry cartridges of the set of treating chemistry cartridges 60a, 60b, 60c can be any type of removable container configured to store multiple doses of a treating chemistry. As a non-limiting example, the second treating chemistry cartridge 60b can be removable from the respective body of the set of bodies 56. The treating chemistry cartridge of the set of treating chemistry cartridges that are removable from the respective body of the set of bodies 56 are selectively receivable within a respective receiver of the set of receivers 86. For purposes of illustration, the second treating chemistry cartridge 60b is shown removed from the respective receiver of the set of receivers 86.

The first treating chemistry cartridge 60a, the second treating chemistry cartridge 60b, the third treating chemistry cartridge 60c, and any other treating chemistry cartridge takes various forms. As a non-limiting example, the second treating chemistry cartridge 60b can be smaller than the first treating chemistry cartridge 60a. Put another way, the second treating chemistry cartridge 60b can hold a smaller total volume of treating chemistry than the first treating chemistry cartridge 60a.

Each treating chemistry cartridge of the set of treating chemistry cartridges 60a, 60b, 60c can take various shapes. As a non-limiting example, the set of treating chemistry cartridges 60a, 60b, 60c can be a rectangular prism, cylindrical, a triangular prism, a hexagonal prism, or the like. As a non-limiting example, the first treating chemistry cartridge 60a and the second treating chemistry cartridge 60b can each be rectangular prisms, while the third treating chemistry cartridge 60c can be a cylinder. Each treating chemistry cartridge of the set of treating chemistry cartridges 60a, 60b, 60c may be flexible, rigid, expandable, or collapsible. Each treating chemistry cartridge of the set of treating chemistry cartridges 60a, 60b, 60c may be made of any type of material. Some examples of suitable cartridges are, without limitation, a plastic container, a cardboard container, a coated cardboard container, and a bladder, all of which are capable of being received within the chemistry hub 92.

Each cartridge of the plurality of treating chemistry cartridges is one of a non-refillable cartridge or a refillable cartridge. As a non-limiting example, the second treating chemistry cartridge 60b and the third treating chemistry cartridge 60c can be non-refillable, replaceable cartridges. As used herein, a “non-refillable cartridge” or a “replaceable cartridge” is defined as a treating chemistry cartridge that includes a volume of treating chemistry that once depleted is not refillable. As a non-limiting example, once the volume of treating chemistry from the second treating chemistry cartridge 60b is depleted, the second treating chemistry cartridge 60b can be removed from the respective receiver of the set of receivers 86 to define an old second treating chemistry cartridge 60b. A new second treating chemistry cartridge 60b with a full or partially full volume of treating chemistry can be received within the respective receiver of the set of receivers 86 to replace the old second treating chemistry cartridge 60b. Put another way, at least a portion of the set of treating chemistry cartridges 60a, 60b, 60c, aside from the mechanism for dispensing, can be formed without a way to access the treating chemistry reservoir of the plurality of treating chemistry reservoirs 42 housed within the second the at least the portion of the set of treating chemistry cartridges 60a, 60b, 60c without breaking the second treating chemistry cartridge 60b and the third treating chemistry cartridge 60c.

As a non-limiting example, the first treating chemistry cartridge 60a can be refillable such that the treating chemistry housed within the treating chemistry cartridge 60a can be refilled. As a non-limiting example, the first treating chemistry cartridge 60a can include a set of closures 62 that provide selective access to the treating chemistry reservoir(s) of the plurality of treating chemistry reservoirs 42 housed within the first treating chemistry cartridge 60a. As a non-limiting example, the first treating chemistry cartridge 60a holds or otherwise defines the first through fourth treating chemistry reservoir 60a-d. As such, the first treating chemistry cartridge 60a can include four closures of the set of closures 62, with each singular closure providing selective access to a singular one of the treating chemistry reservoir of first through fourth treating chemistry reservoir 60a-d.

For purposes of illustration, the treating chemistry manifold 44 (FIG. 1) has been removed from the first treating chemistry module 94a. It will be appreciated, however, that at least a portion of the treating chemistry manifold 44 extends through the first treating chemistry module 94a and is fluidly coupled to the plurality of treating chemistry reservoirs 42 housed by the first treating chemistry module 94a. The set of treating chemistry cartridges 60a, 60, 60c is designed such that the treating chemistry reservoirs of the plurality of treating chemistry reservoirs 42 defined by the set of treating chemistry cartridges 60a, 60, 60c are selectively fluidly coupled to the treating chemistry manifold 44 when the treating chemistry cartridges are received within the set of receivers 86 or otherwise within the respective body of the set of bodies 56.

While not illustrated, the first treating chemistry module 94a can include structure adapted to allow for the treating chemistry manifold 44 to access the treating chemistry housed within the set of cartridges 60a, 60b, 60c. As a non-limiting example, each body of the set of bodies 56 can include at least one of a valve for dispensing the treating chemistry, a cannula or needle used to puncture the cartridge and open a fluid coupling between the treating chemistry reservoir housed by the cartridge and the treating chemistry manifold 44, a pump, a gravity valve, or the like.

While not illustrated, it will be appreciated that the first treating chemistry module 94a, specifically the controller module 46 (FIGS. 1 and 2), can include a system to detect a variety of information related to the treating chemistry, reservoirs, and/or cartridges 60a, 60b, 60c within the first treating chemistry module 94a . . . . By way of non-limiting example an indicator can indicate the amount of treating chemistry within a respective treating chemistry reservoir of the plurality of treating chemistry reservoirs 42. The indicator may be any suitable type of indicator, such as a float indicator, for indicating the amount of treating chemistry within a respective treating chemistry reservoir of the plurality of treating chemistry reservoirs 42. The indicator may also be a sensor that senses the amount of treating chemistry and/or the presence or absence of treating chemistry within the respective treating chemistry reservoir of the plurality of treating chemistry reservoirs 42. Further, the indicator may sense the presence of a cartridge of the set of treating chemistry cartridges 60a, 60b, 60c in general. Regardless of the type, the indicator may send a signal indicative of the amount of the treating chemistry or the presence of treating chemistry.

Furthermore, the first treating chemistry module 94a, specifically the controller module 46 (FIGS. 1 and 2), can detect the type of treating chemistry within a respective treating chemistry reservoir of the plurality of treating chemistry reservoirs 42. As a non-limiting example, each treating chemistry cartridge of the set of treating chemistry cartridges 60a, 60b, 60c can include a presence indicator (e.g., an NFC tag, an RFID tag, a magnet, a notch, a divot, a dimple, a QR code, or the like) that indicates at least one of the presence of the treating chemistry cartridge, what type of treating chemistry is located within the respective treating chemistry cartridge, or a combination thereof. The controller module 46 can access the memory 50 (FIGS. 1 and 2) to determine which treating chemistry is within the respective treating chemistry cartridge. As a non-limiting example, a user of the treating chemistry distribution system 40 can input, via an electronic communication (e.g., through their cellular phone) or a physical communication (e.g., a button, knob, dial, etc.) which treating chemistry is provided in which receiver of the set of receivers 86. As a non-limiting example, each treating chemistry reservoir 42 can correspond to a single treating chemistry such that a user should only load the correct treating chemistry in its correct treating chemistry reservoir 42. As a non-limiting example, each treating chemistry reservoir 42 can correspond to one or more treating chemistry devices of the set of treating chemistry devices 88 via a treating chemistry manifold 44.

FIG. 4 is a schematic diagram of the treating chemistry distribution system 40 of FIG. 1. The plurality of treating chemistry reservoirs 42 include any number of one or more treating chemistry reservoirs. As a non-limiting example, the plurality of treating chemistry reservoirs 42 include the first treating chemistry reservoir 66a, the second treating chemistry reservoir 66b, the third treating chemistry reservoir 66c, the fourth treating chemistry reservoir 66d, the fifth treating chemistry reservoir 66e, and the sixth treating chemistry reservoir 66f. For the sake of illustration, the first treating chemistry module 94a (FIG. 2), the second treating chemistry module 94b (FIG. 2), and the third treating chemistry module 94c (FIG. 2) have been removed from the treating chemistry distribution system 40. For the sake of illustration, the first treating chemistry cartridge 60a (FIG. 3), the second treating chemistry cartridge 60b (FIG. 3), and the third treating chemistry cartridge 60c (FIG. 3) have been removed from the treating chemistry distribution system 40.

The plurality of treating chemistry devices 88 includes, as a non-limiting example, a first treating chemistry device 74a, a second treating chemistry device 74b, a third treating chemistry device 74c, a fourth treating chemistry device 74d, a fifth treating chemistry device 74e, and a sixth treating chemistry device 74f. The treating chemistry manifold 44 fluidly couples the first treating chemistry reservoir 66a to the first treating chemistry device 74a, the second treating chemistry reservoir 66b to the second treating chemistry device 74b, the third treating chemistry reservoir 66c to the third treating chemistry device 74c, the fourth treating chemistry reservoir 66d the a fourth treating chemistry device 74d, the fifth treating chemistry reservoir 66e to the fifth treating chemistry device 74e, and the sixth treating chemistry reservoir 66f to the sixth treating chemistry device 74f. The first through sixth treating chemistry devices 74a-f is any suitable combination of treating chemistry devices of the set of treating chemistry devices 88 or any other treating chemistry device described herein.

The treating chemistry manifold 44 includes a plurality of treating chemistry conduits extending through the interior 58 and being directly fluidly coupled to the plurality of treating chemistry reservoir 42. As a non-limiting example, treating chemistry manifold 44 includes a first treating chemistry conduit 68a, a second treating chemistry conduit 68b, a third treating chemistry conduit 68c, a fourth treating chemistry conduit 68d, a fifth treating chemistry conduit 68e, and a sixth treating chemistry conduit 68f fluidly coupled or otherwise extending from the first treating chemistry reservoir 66a, the second treating chemistry reservoir 66b, the third treating chemistry reservoir 66c, the fourth treating chemistry reservoir 66d, the fifth treating chemistry reservoir 66e, and the sixth treating chemistry reservoir 66f, respectively.

The treating chemistry manifold 44 includes a set of supply lines 72a, 72b, 72c, 72d, 72e, 72f fluidly coupling the plurality of treating chemistry conduits 68a, 68b, 68c, 68d, 68e, 68f to the set of treating chemistry devices (e.g., the first through sixth treating chemistry devices 74a-f). As a non-limiting example, the treating chemistry manifold 44 includes a first treating chemistry conduit 68a extending to the first treating chemistry devices 74a. The treating chemistry manifold 44 includes a second treating chemistry conduit 68b extending to the second treating chemistry devices 74b. The treating chemistry manifold 44 includes a third treating chemistry conduit 68c extending to the third treating chemistry devices 74c. The treating chemistry manifold 44 includes a fourth treating chemistry conduit 68d extending to the fourth treating chemistry devices 74d. The treating chemistry manifold 44 includes a fifth treating chemistry conduit 68e extending to the fifth treating chemistry devices 74e. The treating chemistry manifold 44 includes a sixth treating chemistry conduit 68f extending to the sixth treating chemistry devices 74f.

The treating chemistry manifold 44 can include a set of flow controllers 70a, 70b, 70c, 70d, 70e, 70f selectively fluidly coupling the plurality of treating chemistry conduits to the set of supply lines 72a, 72b, 72c, 72d, 72e, 72f. Each flow controller of the set of flow controllers 70a, 70b, 70c, 70d, 70e, 70f is one of a check valve, an on-off valve, a diverter valve, a pump, a venturi, a heater, or the like. Generally, each flow controller of the set of flow controllers 70a, 70b, 70c, 70d, 70e, 70f is configured to take a fluid from an upstream portion of the flow controller (e.g., from the treating chemistry conduit) and at least one of change the pressure, velocity, temperature, state (e.g., gas, liquid, solid), or turbulence of the fluid. As a non-limiting example, treating chemistry manifold 44 includes a first flow controller 70a, a second flow controller 70b, a third flow controller 70c, a fourth flow controller 70d, a fifth flow controller 70e, and a sixth flow controller 70f fluidly coupling or otherwise extending between the first treating chemistry conduit 68a to at least a first supply line 72a, the second treating chemistry conduit 68b to at least a second supply line 72b, the third treating chemistry conduit 68c to at least a third supply line 72c, the fourth treating chemistry conduit 68d to at least a fourth supply line 72d, the fifth treating chemistry conduit 68e to at least a fifth supply line 72e, and the sixth treating chemistry conduit 68f to at least a sixth supply line 72f, respectively.

The plurality of treating chemistry conduits 68a, 68b, 68c, 68d, 68e, 68f, the set of flow controllers 70a, 70b, 70c, 70d, 70e, 70f, and the set of supply lines 72a, 72b, 72c, 72d, 72e, 72f collectively define a set of flow paths. The first treating chemistry conduit 68a, the first supply line 72a, and optionally the first flow controller 70a (if included) collectively define a first flow path. The second treating chemistry conduit 68b, the second supply line 72b, and optionally the second flow controller 70b (if included) collectively define a second flow path. The third treating chemistry conduit 68c, the third supply line 72c, and optionally the third flow controller 70c (if included) collectively define a third flow path. The fourth treating chemistry conduit 68d, the fourth supply line 72d and optionally the fourth flow controller 70d (if included) collectively define a fourth flow path. The fifth treating chemistry conduit 68e, the fifth supply line 72e and optionally the fifth flow controller 70e (if included) collectively define a fifth flow path. The sixth treating chemistry conduit 68f, the sixth supply line 72f and optionally the sixth flow controller 70f (if included) collectively define a sixth flow path.

At least a portion of the treating chemistry distribution system 40 can be formed by an existing structure or architecture of the environment. As a non-limiting example, the treating chemistry distribution system 40 can include a water line 90. Specifically, at least one of the set of supply lines 72a, 72b, 72c, 72d, 72e, 72f can be formed at least in part by the water line 90. The water line 90 can form a portion of the treating chemistry manifold 44. The water line 90 is fluidly coupled to a water input 76. The water input 76 is defined as a water source of the structure 9 (FIG. 1). As a non-limiting example, the water input 76 can be a supply line or water input that brings water into the structure 9 from exterior the structure 9. The water line 90 can be an existing portion of a water distribution system within the structure 9. As a non-limiting example, the water line 90 can be pipes, tubes, or conduits that distribute water throughout the structure 9. The water input 76 can be a cold water input (e.g., water directly from the supply line or water input that brings in water from exterior the structure 9), a hot water input (e.g., water that is heated by, for example, a heater, boiler, or the like within the structure 9), or a combination thereof.

As a non-limiting example, the first treating chemistry device 74a and the second treating chemistry device 74b can be fluidly coupled to the water line 90. As such, the first supply line 72a and the second supply line 72b can be configured as a cold water input to at least one of the first treating chemistry device 74a, the second treating chemistry device 74b, or a combination thereof. The first supply line 72a and the second supply line 72b can be defined, in part, by the water line 90. As such, treating chemistry from at least one of the first treating chemistry reservoir 66a, the second treating chemistry reservoir 66b, or a combination thereof can be fed through the first treating chemistry conduit 68a and the second treating chemistry conduit 68b, respectively, to the first supply line 72a and the second supply line 72b, respectively, and hence to at least one of the first treating chemistry device 74a, the second treating chemistry device 74b, or a combination thereof through at least a portion of the water line 90. As such, during operation, at least one of a first treating chemistry from the first treating chemistry reservoir 66a, a second treating chemistry from the second treating chemistry reservoir 66b, or a combination thereof can be fed to the water line 90 and mixed with water from the water input 76. Put another way, at least one treating chemistry device of the set of treating chemistry devices 88 can receive a flow of water, treating chemistry, or a combination thereof through the water line 90. Put another way, the treating chemistry manifold 44 is fluidly coupled to one or more treating chemistry device of the set of treating chemistry devices 88 through the water line 90. As such, the treating chemistry distribution system 40 can supply a flow of treating chemistry from at least one treating chemistry reservoir of the plurality of treating chemistry reservoirs 42 through the water line 90.

It will be appreciated that the treating chemistry manifold 44 can have various configurations. As a non-limiting example, each of the first through sixth supply line 72a-f can be fluidly coupled to a singular treating chemistry device of the set of treating chemistry devices 88. As a non-limiting example, a single treating chemistry device of the set of treating chemistry devices 88 can receive a two or more treating chemistries or a combination of treating chemistries (e.g., a mixture of treating chemistries) from the plurality of treating chemistry reservoirs 42 through a common-line configuration (e.g., the first treating chemistry device 74a, and the second treating chemistry device 74b as illustrated). As a non-limiting example, the plurality of treating chemistry reservoirs 42 can be fluidly couplable to a common conduit or line (e.g., the water line 90) that feeds to one or more treating chemistry devices of the set of treating chemistry devices 88. In such a configuration, the treating chemistry from the plurality of treating chemistry reservoirs 42 can be selectively fed to the common conduit or line and then distributed to one or more treating chemistry devices of the set of treating chemistry devices 88.

It will be appreciated that one or more portions of the treating chemistry manifold 44 illustrated as exterior of a respective body of the set of bodies 56 can be located along the respective body of the set of bodies 56 or within the interior 58 of the respective body of the set of bodies 56. As a non-limiting example, one or more flow controllers of the set of flow controllers 70a, 70b, 70c, 70d, 70e, 70f can be located within the interior 58 or along the respective body of the set of bodies 56. As a non-limiting example, a portion of the water line 90 can be routed along the respective body of the set of bodies 56 or within the interior 58. As such, at least a portion of the water line 90 can be formed along the respective body of the set of bodies 56 or within the interior 58.

During operation, the set of treating chemistry devices (e.g., the first through sixth treating chemistry devices 74a-f) operate according to a cycle of operation. The cycle of operation is any suitable step or series of steps by the treating chemistry device. It is contemplated that the cycle of operation can be any suitable cycle including but not limited to a treating cycle of operation including by way of further non-limiting example a cleaning cycle of operation. By way of further non-limiting examples this can include, a wash cycle of the dishwasher 14 (FIG. 1), a cleaning of the oven 16 (FIG. 1), a cleaning of the range 18 (FIG. 1), a cleaning of the microwave 20 (FIG. 1), a cleaning of the refrigerator 22 (FIG. 1), a wash cycle of the laundry treating appliance 24 (FIG. 1), a cleaning of the garbage disposal 26 (FIG. 1), an action of or a cleaning of the faucet 30 (FIG. 1), an actuation of the soap dispenser 32 (FIG. 1), a use of the water heater 34 (FIG. 1), a cleaning of the countertop appliance 36 (FIG. 1), or a filling of the moveable treating chemistry device 38 (FIG. 1). The need for treating chemistry to be fed to the set of treating chemistry devices (e.g., the first through sixth treating chemistry devices 74a-f) will hereinafter be referred to as the operational state of the treating chemistry device. Treating chemistry from at least one of the plurality of treating chemistry reservoirs 42 is fed to at least one treating chemistry device of at least the first through sixth treating chemistry devices 74a-f based on the operational state of at least the first through sixth treating chemistry devices 74a-f. As a non-limiting example, a first treating chemistry from the first treating chemistry reservoir 66a can be fed to the first treating chemistry device 74a via the first flow path (e.g., the first treating chemistry conduit 68a, the first supply line 72a and optionally the first flow controller 70a) based on an operational state of the first treating chemistry device 74a.

It will be appreciated that fluidly coupling the at least one supply line to the water line 90, which forms a portion of the water distribution system of the structure 9, allows for the treating chemistry distribution system 40 to be retrofittable. As a non-limiting example, the first treating chemistry device 74a does not need a special structure to be directly fluidly coupled to the treating chemistry manifold 44. Instead, the treating chemistry manifold 44 can be fluidly coupled to the water line 90, which is fluidly coupled to the first treating chemistry device 74a.

The controller module 46 can receive information from the set of treating chemistry devices 88 within the structure 9 regarding an operational state thereof. The controller module 46 can be used to operate and selectively fluidly couple the chemistry hub 92 to the set of treating chemistry devices 88. As a non-limiting example, to feed a first treating chemistry of the first treating chemistry reservoir 66a to the first treating chemistry device 74a, the processor 48 commands the first flow controller 70a to fluidly couple the first treating chemistry conduit 68a to the first supply line 72a and the water line 90.

The controller module 46 can further be used to determine a fill state of each treating chemistry reservoir of the plurality of treating chemistry reservoirs 42. As a non-limiting example, at least one treating chemistry reservoir of the plurality of treating chemistry reservoirs 42 can include a fill sensor (not illustrated) that determines a total volume of treating chemistry within the at least one treating chemistry reservoir. The processor 48 of the controller module 46 can be communicatively coupled with the fill sensor. Through communication with the fill sensor, once the treating chemistry within the at least one treating chemistry reservoir falls below a threshold fill value, the processor 48 can determine that the treating chemistry of the at least one treating chemistry reservoir needs to be refilled or otherwise the treating chemistry cartridge holding the treating chemistry needs to be replaced.

It is contemplated that the treating chemistry distribution system 40 can produce an alert if at least one treating chemistry reservoir of the plurality of treating chemistry reservoirs 42 needs to be refilled or replaced based on the fill state of the at least one treating chemistry reservoir. The alert is any suitable alert or combination of alerts. As a non-limiting example, the alert can include at least one of a physical alert (e.g., a vibration), an audible alert (e.g., an alarm, a whistle, etc.), a visual alert (e.g., a strobe, a light, etc.), an electronic alert, or a combination thereof. The electronic alert is any suitable alert that is sent to an electronic device. As a non-limiting example, the alert can be a wired transmission or a wireless transmission over a wireless network (e.g., Bluetooth, Wi-Fi, etc.) that is received by an electronic device (e.g., a tablet, computer, cellular phone, etc.) of a user of the treating chemistry distribution system 40. As a non-limiting example, the alert can be a transmission or a command sent to at least one of the first through sixth treating chemistry devices 74a-f. As a non-limiting example, if the alert is indicative of the fact that a certain treating chemistry is not present or otherwise there is not enough of the certain treating chemistry for the treating chemistry device to properly function, the alert can command the respective treating chemistry device not to operate or otherwise function until the certain treating chemistry is replaced or refilled. It will be appreciated that the alert, based on the sensed fill level of each treating chemistry reservoir of the plurality of treating chemistry reservoirs 42, can be an indication that at least one treating chemistry reservoir is at the threshold fill value, approaching the threshold fill value (e.g., above the threshold fill value, but getting near to the threshold fill value), or otherwise completely out.

FIG. 5 is a flow diagram illustrating a method 80 of utilizing the treating chemistry distribution system 40 of FIG. 1. The method 80 includes determining an operational state of a respective treating chemistry device of the set of treating chemistry devices 88 (FIG. 1), at 82. It will be appreciated that the treating chemistry distribution system 40 can be communicatively coupled to the set of treating chemistry devices 88. When a user of the set of treating chemistry devices 88 begins a treating cycle (e.g., enters an operational state requiring the treating chemistry) of the respective treating chemistry device, the respective treating chemistry device can communicate via a wired or wireless transmission to the controller module 46 the operational state of the respective treating chemistry device. Alternatively, the user of the respective treating chemistry device can manually input via a button, knob, or wireless communication (e.g., through their cellular phone) an indication of the operational state of the respective treating chemistry device. Once the operational state of the treating chemistry device 88 has been determined to need an input of treating chemistry from at least one treating chemistry reservoir of the plurality of treating chemistry reservoirs 42 (FIG. 3), a flow of treating chemistry can be fluidly coupled to at least one treating chemistry reservoir of the plurality of treating chemistry reservoirs 42 to the respective treating chemistry device, via the treating chemistry manifold 44, at 84. The feeding of the flow of treating chemistry from the at least one treating chemistry reservoir to the respective treating chemistry device is done by, for example, selectively fluidly coupling a respective treating chemistry conduit (e.g., the first through sixth treating chemistry conduits 68a-f) to a respective supply line (e.g., the first through sixth supply lines 72a-f) of the treating chemistry manifold 44.

The sequences depicted is for illustrative purposes only and is not meant to limit the methods 80 in any way as it is understood that the portions of the method can proceed in a different logical order, additional or intervening portions can be included, or described portions of the method can be divided into multiple portions, or described portions of the method can be omitted without detracting from the described method. For example, the method 80 can include various other additional or intervening portions. The examples provided herein are meant to be non-limiting.

As a non-limiting example, the method 80 can include detecting, via the controller module 46, a fill level of each treating chemistry reservoir of the plurality of treating chemistry reservoirs 42. The method 80 can include generating the alert if the fill level of at least one treating chemistry reservoir of the plurality of treating chemistry reservoirs 42 falls below a threshold value of the fill level. As a non-limiting example, the method 80 can include the alert being at least one of a physical transmission, a visual transmission, an audible transmission, or a transmission sent to an electronic device. As a non-limiting example, the method 80 can include receiving, at the controller module 46, a signal from a respective treating chemistry device of the plurality of treating chemistry devices 88 concerning the low-fille state (e.g., below the threshold value) of a chemistry or an insufficient amount of treating chemistry being fed to the respective treating chemistry device. The method 80 can further include generating the alert based on the received signal from the respective treating chemistry device. As a non-limiting example, if the controller module 46 determines that a respective treating chemistry is running low or is otherwise depleted (e.g., below the threshold fill value), the method 80 can include automatically ordering replacement cartridges, vessels, or other bodies containing the respective treating chemistry in order to refill or replace the respective treating chemistry.

As a non-limiting example, the method 80 can include fluidly coupling a first flow of treating chemistry from a first treating chemistry reservoir (e.g., the first treating chemistry reservoir 66a of FIG. 3) of the plurality of treating chemistry reservoirs 42, via the treating chemistry manifold 44, during a first operational state of the treating chemistry device (e.g., the first treating chemistry device 74a of FIG. 3). The method 80 can include fluidly coupling a second flow of treating chemistry from a second treating chemistry reservoir (e.g., the second treating chemistry reservoir 66b of FIG. 3) of the plurality of treating chemistry reservoirs 42, via the treating chemistry manifold 44, during a second operational state of the treating chemistry device (e.g., the first treating chemistry device 74a of FIG. 3). Put another way, the first treating chemistry device 74a can have two or more operational states. Each operational state can utilize a flow of treating chemistry from different treating chemistry reservoirs of the plurality of treating chemistry reservoirs 42. As a non-limiting example, the first operational state can be a wash cycle, while the second operational state can be a cleaning cycle of the first treating chemistry device 74a. As a non-limiting example, the first operational state can be a first portion of a wash cycle, while the second operational state can be a second portion of the wash cycle.

As a non-limiting example, the method 80 can include fluidly coupling, at a first time and based on the operational state of a first treating chemistry device (e.g., the first treating chemistry device 74a) of the set of treating chemistry devices 88 (FIG. 1), a flow of treating chemistry from at least one treating chemistry reservoir of the plurality of treating chemistry reservoirs 42 to the first treating chemistry device, via the treating chemistry manifold. The method 80 can include fluidly coupling, at a second time and based on the operational state of a second treating chemistry device (e.g., the second treating chemistry device 74b of FIG. 3) of the set of treating chemistry devices 88, a flow of treating chemistry from at least one treating chemistry reservoir of the plurality of treating chemistry reservoirs 42 to the second treating chemistry device, via the treating chemistry manifold. It will be appreciated that the first time can be the same time as the second time. Put another way, two or more treating chemistry devices can be used at the same time. The treating chemistry distribution system can supply the appropriate flow of treating chemistry from the plurality of treating chemistry reservoirs to the appropriate treating chemistry device. Alternatively, the first time can be at a different time from the first time. It will be appreciated that automatic fluid coupling of the first flow of chemistry and the second flow of chemistry can be done through use of the controller module 46.

As a non-limiting example, the method 80 can include fluidly coupling the flow of treating chemistry to a supply line (e.g., the first through sixth supply lines 72a-f of FIG. 3) being configured as a cold water line (e.g., the water line 90 of FIG. 3).

FIG. 6 is a schematic diagram of an exemplary treating chemistry distribution system 140 suitable for use as the treating chemistry distribution system 40 of FIG. 1. The treating chemistry distribution system 140 is similar to the treating chemistry distribution system 40 (FIG. 1); therefore, like parts will be identified with like numerals increased to the 100 series with it being understood that the description of the treating chemistry distribution system 40 applies to the treating chemistry distribution system 140 unless noted otherwise.

The treating chemistry distribution system 140 includes a treating chemistry hub 192 housing a plurality of treating chemistry reservoirs 142. The treating chemistry hub 192 can include A set of bodies 156 defining an interior 158. The set of bodies 156 house the plurality of treating chemistry reservoirs 142. The plurality of treating chemistry reservoirs 142 can include a first treating chemistry reservoir 166a, a second treating chemistry reservoir 166b, a third treating chemistry reservoir 166c, a fourth treating chemistry reservoir 166d, a fifth treating chemistry reservoir 166e, and a sixth treating chemistry reservoir 166f. The treating chemistry distribution system 140 can include a controller module 146 having a processor 148 and a memory 150. It will be appreciated that the treating chemistry hub 192 can be formed similar to the treating chemistry hub 92 (FIGS. 1-4) and include a set of treating chemistry modules (e.g., the first treating chemistry module 94a, the second treating chemistry module 94b, the third treating chemistry module 94c, etc.).

The treating chemistry distribution system 140 can include a treating chemistry manifold 144. The treating chemistry manifold 144 includes a plurality of treating chemistry conduits 168a, 168b, 168c, 168d, 168e, 168f and a set of supply lines 172a, 172b, 172c, 172d, 172e, 172f. The plurality of treating chemistry conduits 168a, 168b, 168c, 168d, 168e, 168f include a first treating chemistry conduit 168a, a second treating chemistry conduit 168b, a third treating chemistry conduit 168c, a fourth treating chemistry conduit 168d, a fifth treating chemistry conduit 168e, and a sixth treating chemistry conduit 168f. The set of supply lines 172a, 172b, 172c, 172d, 172e, 172f includes a first supply line 172a, a second supply line 172b, a third supply line 172c, a fourth supply line 172d, a fifth supply line 172e and a sixth supply line 172f. The treating chemistry manifold 144 fluidly couples the plurality of treating chemistry reservoirs 142 to a set of treating chemistry devices 188. The treating chemistry manifold 44 fluidly couples the first treating chemistry reservoir 166a to a first treating chemistry device 174a, the second treating chemistry reservoir 166b to a second treating chemistry device 174b, the third treating chemistry reservoir 166c to a third treating chemistry device 174c, the fourth treating chemistry reservoir 166d to a fourth treating chemistry device 174d, the fifth treating chemistry reservoir 166e to a fifth treating chemistry device 174e, and the sixth treating chemistry reservoir 166f to a sixth treating chemistry device 174f. The first through sixth treating chemistry devices 174a-f is any suitable combination of treating chemistry devices of the set of treating chemistry devices 188 or any other treating chemistry device described herein.

The treating chemistry distribution system 140 is similar to the treating chemistry distribution system 40 in that the treating chemistry manifold 144 can include a set of flow controllers 170a, 170b. However, the treating chemistry manifold 144 includes two flow controllers, with a singular flow controller having two or more inputs and at least one output. As a non-limiting example, the set of flow controllers 170a, 170b include a first flow controller 170a and a second flow controller 170b. The first flow controller 170a fluidly couples at least one of the first treating chemistry conduit 168a, the second treating chemistry conduit 168b, the third treating chemistry conduit 168c, or a combination thereof to at least one of the first supply line 172a and hence the first treating chemistry device 174a, the second supply line 172b. The second flow controller 170b fluidly couples at least one of the fourth treating chemistry conduit 168d, the fifth treating chemistry conduit 168e, the sixth treating chemistry conduit 168f, or a combination thereof to at least one of the fourth supply line 172d, the fifth supply line 172e, the sixth supply line 172f, or a combination thereof.

The treating chemistry distribution system 140, like the treating chemistry distribution system 40, can include a water line 190. At least a portion of the treating chemistry manifold 144 is formed by the water line 190. At least one of the set of supply lines 172a, 172b, 172c, 172d, 172e, 172f can be fluidly coupled to the water line 90. Specifically, the set of supply lines 172a, 172b, 172c, 172d, 172e, 172f are fluidly coupled to the water line 90 at a set of locations 191. The water line 190 is fluidly coupled to one or more treating chemistry devices of the set of treating chemistry devices 188. The water line 190 receives a flow of water from a water input 176 of a structure including the treating chemistry distribution system 140 (e.g., the structure 9 of FIG. 1).

The difference between the treating chemistry distribution system 140 and the treating chemistry distribution system 40 is that each of the first through sixth supply line 172a-f is at least partially formed by water line 190. The water line 190 is then fluidly coupled to at least a portion of the set of treating chemistry devices 188 (e.g., the first through sixth treating chemistry devices 174a-f). As such, at least one of a first treating chemistry from the first treating chemistry reservoir 166a, a second treating chemistry from the second treating chemistry reservoir 166b, a third treating chemistry from the third treating chemistry reservoir 166c, a fourth treating chemistry from the fourth treating chemistry reservoir 166d, a fifth treating chemistry from the fifth treating chemistry reservoir 166e, a the treating chemistry from the sixth treating chemistry reservoir 166f, or a combination thereof can be fed to at least one treating chemistry device or a combination of treating chemistry devices of the set of treating chemistry devices 188.

The set of flow controllers 170a, 170b can further include a distribution valve 194 located along the water line 190. The distribution valve 194 is configured to supply at least one of a flow of water from the water input 176, a flow of treating chemistry from at least one treating chemistry reservoir of the plurality of treating chemistry reservoirs 142, or a combination thereof to at least one treating chemistry device of the set of treating chemistry devices 188.

The use of the first flow controller 170a, the second flow controller 170b, the distribution valve 194, or a combination thereof allows for a singular treating chemistry from a singular treating chemistry reservoir to be fed to multiple treating chemistry devices of the set of treating chemistry devices 188, for multiple treating chemistries from multiple treating chemistry reservoirs to be fed to a singular treating chemistry device of the set of treating chemistry devices 188, or a combination thereof. The use of the distribution valve 194 allows for treating chemistry distribution system 140 to be applied to an existing environment that includes the water line 190 that feeds to one or more treating chemistry device of the set of treating chemistry devices 188.

It will be appreciated that one or more portions of the treating chemistry manifold 144 illustrated as exterior of a respective body of the set of bodies 156 can be located along the respective body of the set of bodies 156 or within the interior 158 of the respective body of the set of bodies 156. As a non-limiting example, one or more flow controllers of the set of flow controllers 170a, 170b can be located within the interior 158 or along the respective body of the set of bodies 156. As a non-limiting example, a portion of the water line 190 can be routed along the respective body of the set of bodies 156 or within the interior 158. As such, at least a portion of the water line 190 can be formed along the respective body of the set of bodies 156 or within the interior 158. As a non-limiting example, the distribution valve 194 can be located along the respective body of the set of bodies 156 or within the interior 158.

FIG. 7 is a schematic perspective view of a portion of an exemplary treating chemistry distribution system 240 suitable for use as the treating chemistry distribution system 140 of FIG. 1. The treating chemistry distribution system 240 is similar to the treating chemistry distribution system 40 (FIG. 1), 140 (FIG. 5); therefore, like parts will be identified with like numerals increased to the 200 series with it being understood that the description of the treating chemistry distribution system 40, 140 applies to the treating chemistry distribution system 240 unless noted otherwise.

The treating chemistry distribution system 240 includes a treating chemistry hub 292. The treating chemistry hub 292 can include A set of bodies 256 defining an interior 258. A set of treating chemistry cartridges 260a, 260b, 260c, 260d, 260e, 260f is receivable within the interior 258. The set of treating chemistry cartridges 260a, 260b, 260c, 260d, 260e, 260f can include a first treating chemistry cartridge 260a, a second treating chemistry cartridge 260b, a third treating chemistry cartridge 260c, a fourth treating chemistry cartridge 260d, a fifth treating chemistry cartridge 260e, and a sixth treating chemistry cartridge 260f. Each of the first through sixth treating chemistry cartridge 260a-f defines a respective treating chemistry reservoir of a plurality of treating chemistry reservoirs (e.g., the plurality of treating chemistry reservoirs 42 (FIG. 1), 142 (FIG. 5)). Each body of the set of bodies 256 can include a set of receivers 286 adapted to fit the first through sixth treating chemistry cartridges 260a-f, or any other treating chemistry cartridges.

The treating chemistry distribution system 240 is similar to the treating chemistry distribution system 40, in that the treating chemistry distribution system 240 utilizes the set of treating chemistry cartridges 260a, 260b, 260c, 260d, 260e, 260f. The difference, however, is that each treating chemistry cartridge of the plurality of treating chemistry cartridges 260a, 260b, 260c, 260d, 260e, 260f is tubular (e.g., cylindrical) rather than rectangular.

FIG. 8 is a schematic diagram of an exemplary treating chemistry distribution system 340 suitable for use as the treating chemistry distribution system 40 of FIG. 1. The treating chemistry distribution system 340 is similar to the treating chemistry distribution system 40 (FIG. 1), 140 (FIG. 6), 240 (FIG. 7); therefore, like parts will be identified with like numerals increased to the 300 series with it being understood that the description of the treating chemistry distribution system 40, 140, 240 applies to the treating chemistry distribution system 340 unless noted otherwise.

The treating chemistry distribution system 340 includes a treating chemistry hub 392 housing a plurality of treating chemistry reservoirs 342. The plurality of treating chemistry reservoirs 342 can include a first treating chemistry reservoir 366a, a second treating chemistry reservoir 366b, a third treating chemistry reservoir 366c, and a fourth treating chemistry reservoir 366d. The treating chemistry hub 392 can include A set of bodies 356 defining an interior 358. The set of bodies 356 house the plurality of treating chemistry reservoirs 342. The treating chemistry distribution system 340 can include a controller module 346 having a processor 348 and a memory 350. The controller module 346 is configured to receive communications, send communications, or a combination thereof to one or more portions of the treating chemistry distribution system 340. As such, the controller module 346 is communicatively coupled to one or more portions of the treating chemistry distribution system 340. The communication couplings are illustrated in phantom lines leading from the controller module 346 and to various portions of the treating chemistry distribution system 340.

The treating chemistry distribution system 340 can include a treating chemistry manifold 344. The treating chemistry manifold 344 includes a plurality of treating chemistry conduits 368a, 368b, 368c, 368d and a set of supply lines 372a, 372b, 372c, 372d. The plurality of treating chemistry conduits 368a, 368b, 368c, 368d include a first treating chemistry conduit 368a, a second treating chemistry conduit 368b, a third treating chemistry conduit 368c, and a fourth treating chemistry conduit 368d. The set of supply lines 372a, 372b, 372c, 372d includes a first supply line 372a, a second supply line 372b, a third supply line 372c, and a fourth supply line 372d. The treating chemistry manifold 344 fluidly couples the plurality of treating chemistry reservoirs 342 to a set of treating chemistry devices 388. The set of treating chemistry devices 388 can include any suitable combination of treating chemistry devices of the set of treating chemistry devices 88 (FIGS. 1 and 4) or any other treating chemistry device described herein.

The treating chemistry distribution system 340 includes the set of supply lines 372a, 372b, 372c, 372d. The treating chemistry distribution system 340 can include a water line 390. Specifically, at least one of the set of supply lines 372a, 372b, 372c, 372d can be fluidly coupled to the water line 390 at a set of locations 391. The water line 390 is coupled to one or more treating chemistry devices of the set of treating chemistry devices 388. The water line 390 receives a flow of water from a water input. As a non-limiting example, the water line 390 receives a flow of water from at least one of a hot water input 377, a cold water input 379, or a combination thereof of a structure including the treating chemistry distribution system 340 (e.g., the structure 9 of FIG. 1) . . . . A mixing valve 381 fluidly couples the hot water input 377 and the cold water input 379 to the water line 390.

The treating chemistry hub 392, like the treating chemistry hub 92 (FIGS. 1-4), 192 (FIG. 6), includes a treating chemistry hub 392. The difference, however, is that the treating chemistry hub 392 further includes a distribution module 398. The treating chemistry hub 392 defines a housing for the plurality of treating chemistry reservoirs 342. While only a singular treating chemistry module 394 is illustrated, it will be appreciated that the treating chemistry hub 392 can include any number of one or more treating chemistry modules.

The distribution module 398 includes a set of flow controllers 370 similar to the set of flow controllers 70a (FIG. 4), 70b (FIG. 4), 70c (FIG. 4), 70d (FIG. 4), 70e (FIG. 4), 70f (FIG. 4), 170a (FIG. 6), 170b (FIG. 6), 170c (FIG. 6), 170d (FIG. 6), 170e (FIG. 6), 170f (FIG. 6). The set of flow controllers 370 can take various forms. As a non-limiting example, each flow controller of the set of flow controllers 370 can include a motor 304 and a pump 306. The motor 304 is configured to drive the pump 306.

The treating chemistry hub 392 can include an electrical connection 397. The electrical connection 397 is configured to connect one or more electrical components of the treating chemistry hub 392 to a power source of an environment (e.g., the first environment 10 of FIG. 1, the second environment 12 of FIG. 1, etc.). The power source can be, for example, a power mains of the environment, a power generator (e.g., a motor, a renewable energy power source, etc.), a battery, or a combination thereof. The one or more electrical components of the treating chemistry hub 392 are, for example, the set of flow controllers 370 (e.g., the motor 304), and the controller module 346. The set of flow controllers 370 control a flow of treating chemistry from the treating chemistry reservoirs 342 and to the supply lines 372a, 372b, 372c, 372d. As such, the distribution module 398 can be defined as a treating chemistry distribution module.

While the set of flow controllers 370 are illustrated as four separate of the flow controllers 370, it will be appreciated that the set of flow controllers 370 can include any number of one or more flow controllers. As a non-limiting example, the set of flow controllers 370 can include a singular flow controller that fluidly coupled to two or more treating chemistry reservoirs of the plurality of treating chemistry reservoirs 342.

The electrical connection 397 can be directly coupled to the distribution module 398. The distribution module 398 can include wiring (not illustrated) that distributes the electrical power form the electrical connection 397 to the electrical components of the treating chemistry hub 392. In some cases, the one or more electrical components of the treating chemistry hub 392 can be exterior the distribution module 398. As a non-limiting example, the controller module 346 can be exterior the distribution module 398. As such, the distribution module 398 can convey the electrical power exterior the distribution module 398 to, for example, the controller module 346. Put another way, the distribution module 398 can further be defined as an electrical power distribution module.

The distribution module 398 and the treating chemistry module 394 are fluidly connected to each other (e.g., through the plurality of treating chemistry conduits 368a, 368b, 368c, 368d) and optionally electrically connected to each other. In this manner, the distribution module 398 and the treating chemistry module 394 are not integrally formed with each other. It is contemplated that the distribution module 398 is independently removable from treating chemistry hub 392 with respect to the treating chemistry module 394.

The distribution module 398 and the treating chemistry module 394 can be housed within a singular body 356. Put another way, the distribution module 398 and the treating chemistry module 394 can each be located within the interior 358. It is contemplated that the set of bodies 356 can be formed similar to the set of bodies 56 (FIGS. 1-4) and include a set of drawers (e.g., the housing closure 64 of FIG. 3). It is contemplated that each drawer of the set of drawers can hold or otherwise defined a carrier for the distribution module 398 and the treating chemistry module 394. Alternatively, the distribution module 398 and the treating chemistry module 394 can be formed within separate housings that are coupled to one another or otherwise placed near each other.

The treating chemistry distribution system 340 can include a set of check valves 308a, 308b, 308c, 308d for regulating the flow of treating chemistry form the distribution module 398 and to the water line 390. The set of check valves 308a, 308b, 308c, 308d can include a first check valve 308a, a second check valve 308b, a third check valve 308c, and a fourth check valve 308d. The first check valve 308a can be provided along the first supply line 372a. The second check valve 308b can be provided along the second supply line 372b. The third check valve 308c can be provided along the third supply line 372c. The fourth check valve 308d can be provided along the fourth supply line 372d. The set of check valves 308a, 308b, 308c, 308d can be biased to prevent a backflow of fluid from the water line 390 and into the distribution module 398. It will be appreciated that the set of check valves 308a,308b, 308c, 308d can include any number of one or more check valves located along any suitable portion of the treating chemistry distribution system 340. As a non-limiting example, the set of check valves 308a, 308b, 308c, 308d can include one or more check valves located along one or more of the treating chemistry conduit of the plurality of treating chemistry conduits 368a, 368b, 368c, 368d.

The treating chemistry manifold 344 provides a treating chemistry from at least a portion of the plurality of treating chemistry conduits 368a, 368b, 368c, 368d into the water line 390 at the set of locations 391. The water line 390 can include a pressure reducer valve 310. The pressure reducer valve 310 can be provided along a portion of the water line 390 upstream of the set of locations 391. The pressure reducer valve 310 is configured create a pressure drop between an upstream end and a downstream end of the pressure reducer valve 310. Put another way, a pressure of a fluid fed to the pressure reducer valve 310 has a first pressure. The fluid is output from the pressure reducer valve 310 with a second pressure. The first pressure is larger than the second pressure.

The reduction of pressure through use of the pressure reducer valve 310 allows for the treating chemistry to be provided into the water line 390 through the set of supply lines 372a, 372b, 372c, 372d. It is contemplated that the fluid from the water input is at a pressure (e.g., the first pressure) that can be too high to effectively provide the treating chemistry from the set of supply lines 372a, 372b, 372c, 372d into the water line 390.

Further, the use of the pressure reducer valve 310 reduces a needed power of the treating chemistry hub 392. Specifically, it is contemplated that the set of flow controllers 370 of the treating chemistry hub 392 pressurize the treating chemistry when the feeding the treating chemistry from the plurality of treating chemistry conduits 368a, 368b, 368c, 368d and to the set of supply lines 372a, 372b, 372c, 372d. It is contemplated that a larger motor, larger pump, or a combination thereof creates a higher pressure treating chemistry in the set of supply lines 372a, 372b, 372c, 372d in relation to a smaller motor or a smaller pump, respectively. The pressure of the treating chemistry within the set of supply lines 372a, 372b, 372c, 372d is based on the pressure of the fluid within the water line 390 where the set of supply lines 372a, 372b, 372c, 372d is providing the treating chemistry into. As such, if the pressure of the fluid of the water line 390 where the set of supply lines 372a, 372b, 372c, 372d are providing the treating chemistry into is high (e.g., the first pressure), the set of flow controllers 370 must be more powerful to ensure that the treating chemistry within the set of supply lines 372a, 372b, 372c, 372d is high enough to effectively be provided into the water line 390. Using the pressure reducer valve 310 allows for the fluid within the water line 390 to be reduced, thus allowing for a smaller flow controller of the set of flow controllers 370 to be used. It is contemplated that the use of smaller flow controllers of the set of flow controllers 370 reduces a price and footprint of the distribution module 398 in comparison to the distribution module 398 formed with larger (e.g., stronger) flow controllers of the set of flow controllers 370.

The treating chemistry distribution system 340 can include a set of distribution valves 389a, 389b, 389c that fluidly couple the water line 390 to the set of treating chemistry devices 388. The set of distribution valves 389a, 389b, 389c selectively fluidly couple at least one of treating chemistry from one or more treating chemistry reservoir of the plurality of treating chemistry reservoirs 342, hot water from the hot water input 377, cold water from the cold water input 379, or a combination thereof to the set of treating chemistry devices 388 . . . . The set of distribution valves 389a, 389b, 389c are located downstream from the set of locations 391. Each distribution valve of the set of distribution valves 389a, 389b, 389c can fluidly couple the water line 390 to a respective one or more treating chemistry device of the set of treating chemistry devices 388. As a non-limiting example, a first distribution valve 389a can fluidly couple the water line 390 to a first treating chemistry device 388a. A second distribution valve 389b can fluidly couple the water line 390 to a second treating chemistry device 388b. A third distribution valve 389c can fluidly couple the water line 390 to a third treating chemistry device 388c.

FIG. 9 is a schematic diagram of an exemplary treating chemistry distribution system 440 suitable for use as the treating chemistry distribution system 40 of FIG. 1. The treating chemistry distribution system 440 is similar to the treating chemistry distribution system 40 (FIG. 1), 140 (FIG. 6), 240 (FIG. 7), 340 (FIG. 8); therefore, like parts will be identified with like numerals increased to the 400 series with it being understood that the description of the treating chemistry distribution system 40, 140, 240, 340 applies to the treating chemistry distribution system 440 unless noted otherwise.

The treating chemistry distribution system 440 includes a treating chemistry hub 492 housing a plurality of treating chemistry reservoirs 442. The plurality of treating chemistry reservoirs 442 can include a first treating chemistry reservoir 466a, a second treating chemistry reservoir 466b, a third treating chemistry reservoir 466c, a fourth treating chemistry reservoir 466d, a fifth treating chemistry reservoir 466e, and a sixth treating chemistry reservoir 466f. The treating chemistry hub 492 can include a set of bodies 456 defining an interior 458. The set of bodies 456 house the plurality of treating chemistry reservoirs 442. The treating chemistry distribution system 440 can include a controller module 446 having a processor 448 and a memory 450. The controller module 446 is configured to receive communications, send communications, or a combination thereof to one or more portions of the treating chemistry distribution system 440. As such, the controller module 446 is communicatively coupled to one or more portions of the treating chemistry distribution system 440. The communication couplings are illustrated in phantom lines leading from the controller module 446 and to various portions of the treating chemistry distribution system 440.

The treating chemistry distribution system 440 includes a treating chemistry manifold 444. The treating chemistry manifold 444 includes a plurality of treating chemistry conduits 468a, 468b, 468c, 468d, 468e, 468f and a set of supply lines 472a, 472b, 472c, 472d. The plurality of treating chemistry conduits 468a, 468b, 468c, 468d, 468e, 468f include a first treating chemistry conduit 468a, a second treating chemistry conduit 468b, a third treating chemistry conduit 468c, a fourth treating chemistry conduit 468d, a fifth treating chemistry conduit 468e, and a sixth treating chemistry conduit 468f. The set of supply lines 472a, 472b, 472c, 472d includes a first supply line 472a, a second supply line 472b, a third supply line 472c, and a fourth supply line 472d. The treating chemistry manifold 444 fluidly couples the plurality of treating chemistry reservoirs 442 to a set of treating chemistry devices 488. The set of treating chemistry devices 488 can include any suitable combination of treating chemistry devices of the set of treating chemistry devices 88 (FIGS. 1 and 4) or any other treating chemistry device described herein.

The set of treating chemistry devices 488 are split into two; a first set of treating chemistry devices 474a and a second set of treating chemistry devices 474b. The first set of treating chemistry devices 474a are separate from the second set of treating chemistry devices 474b. It will be appreciated that at least one of the first set of treating chemistry devices 474a, the second set of treating chemistry devices 474b, or a combination thereof can include a singular treating chemistry device. As a non-limiting example, the first set of treating chemistry devices 474a can include a plurality of treating chemistry devices, while the second set of treating chemistry devices 474b can include a singular treating chemistry device of the set of treating chemistry devices 488.

It is contemplated that the first set of treating chemistry devices 474a can, for example, include three treating chemistry devices, while the second set of treating chemistry devices 474b can, for example, include one treating chemistry device. A total number of supply lines of the set of supply lines 472a, 472b, 472c, 472d leading from a specific flow controller of the set of flow controllers including first flow controller 489a and second flow controller 489b can correspond to a total number of treating chemistry devices in the first set of treating chemistry devices 474a and the second set of treating chemistry devices 474a. As the first set of treating chemistry devices 474a can, for example, include three treating chemistry devices, three supply lines (e.g., the first through third supply lines 472a-c) define fluid outputs of the first flow controller 489a. As the second set of treating chemistry devices 474b can, for example, include one treating chemistry device, one supply line (e.g., the fourth supply line 472d) defines a fluid output from the second flow controller 489b.

Each respective of the first flow controller 489a and second flow controller 489b has a total number of fluid inputs (e.g., a total number of treating chemistry conduits of the set of treating chemistry conduits 468a, 468b, 468c, 468d, 468e, 468f coupled to the respective flow controller) and a total number of fluid outputs. Each flow controller of the set of flow controllers 489a, 489b can have an equal number of fluid inputs with respect to fluid outputs (e.g., the first flow controller 489a has three fluid inputs and three fluid outputs). Each flow controller of the first flow controller 489a and second flow controller 489b can have a non-equal number of fluid inputs with respect to fluid outputs (e.g., the second flow controller 489b has three fluid inputs and one fluid output).

The treating chemistry distribution system 440 includes a set of flow controllers; specifically, a set of distribution valves 489a, 489b. The set of distribution valves 489a, 489b can include a first distribution valve 489a and a second distribution valve 489b. The set of distribution valves 489a, 489b are any suitable valve. As a non-limiting example, each distribution valve of the set of distribution valves 489a, 489b are a peristaltic pump including a set of tubes and a set of rollers. It is contemplated that a peristaltic pump for the set of distribution valves 489a, 489b allows for the set of distribution valves 489a, 489b to handle a wide range of viscosities and densities of the fluids (e.g., the treating chemistry) that flow through the set of distribution valves 489a, 489b. The plurality of treating chemistry reservoirs 442 can hold differing treating chemistries with respect to one another. It is contemplated that differing treating chemistries can have differing properties (e.g., viscosities, densities, etc.). As such, the plurality of treating chemistry reservoirs 442 can hold differing treating chemistries having differing properties. The use of the peristaltic valve for the set of distribution valves 489a, 489b allows for a singular valve to convey multiple different treating chemistries.

The first distribution valve 489a fluidly couples one or more treating chemistry reservoir of the plurality of treating chemistry reservoirs 442 to the first set of treating chemistry devices 474a. The second distribution valve 489b fluidly couples one or more treating chemistry reservoirs of the plurality of treating chemistry reservoirs 444 to the second set of treating chemistry devices 474b. As a non-limiting example, the first distribution valve 489a fluidly couples the first treating chemistry reservoir, the second treating chemistry reservoir 466b, and the third treating chemistry reservoir 466c to the first set of treating chemistry devices 474a. As a non-limiting example, the second distribution valve 489b fluidly couples the fourth through sixth chemistry reservoirs 466d, 466e, 466f to the second set of treating chemistry devices 474b. Put another way, the treating chemistry distribution system 440 can be set up such that a first subset of the plurality of treating chemistry reservoirs 444 are associated with (e.g., fluidly couplable with) the first set of treating chemistry devices 474a, while a second subset of the plurality of treating chemistry reservoirs 444 are associated with (e.g., fluidly couplable with) the second set of treating chemistry devices 474b.

The treating chemistry distribution system 440 is especially well adapted for use when there are distinct groups defined with the set of treating chemistry devices 488. For example, the first set of treating chemistry devices 474a and the second set of treating chemistry devices 474b differ in such a way that the first set of treating chemistry devices 474a utilize different treating chemistry than the second set of treating chemistry devices 474b. As a non-limiting example, the first set of treating chemistry devices 474a can be defined as appliances that dispense a treating chemistry meant for direct human contact (e.g., soap, hand sanitizer, lotion, etc.). As a non-limiting example, the second set of treating chemistry devices 474b can be defined as appliances that dispense a treating chemistry not meant for direct human contact (e.g., bleach or other cleaning agents, enzyme, rinse aid, laundry detergent, dishwasher chemistry, descaler, etc.). As a non-limiting example, the first set of treating chemistry devices 474a can include a plurality of treating chemistry devices, while the second set of treating chemistry devices 474b can include a singular treating chemistry device that utilizes multiple treating chemistries that are specific to the singular treating chemistry device. As a non-limiting example, the singular treating chemistry device can be a dishwasher that is adapted to utilize dishwasher detergent, enzyme, rinse aid, bleach, or a combination thereof.

The treating chemistry distribution system 440 can further be broken up based on environments. For example, the first set of treating chemistry devices 474a can be located within a first environment (e.g., a first room), while the second set of treating chemistry devices 474b can be located within a second environment (e.g., a second room) different from the first environment. The first distribution valve 489a can be used to distribute treating chemistry to the first environment, while the second distribution valve 489b can be used to distribute treating chemistry to the second environment.

Benefits of the present disclosure include a treating chemistry distribution system adapted to supply appropriate amounts and types of treating chemistry to a plurality of treating chemistry devices based on the operational state of each treating chemistry device of the plurality of treating chemistry devices. Previous methods of supplying treating chemistry to a treating chemistry device include applying the treating chemistry directly to or otherwise loading the treating chemistry into the treating chemistry device. This requires the user to directly load or apply the treating chemistry. The treating chemistry distribution system as described herein, however, provides a treating chemistry hub that defines a singular location where the user must load the treating chemistry. The treating chemistry distribution system then automatically distributes the flow of treating chemistry to the appropriate treating chemistry device based on operational state of the plurality of treating chemistry devices.

To the extent not already described, the different features and structures of the various aspects can be used in combination with each other as desired. That one feature cannot be illustrated in all of the aspects is not meant to be construed that it cannot be, but is done for brevity of description. Thus, the various features of the different aspects can be mixed and matched as desired to form new aspects, whether or not the new aspects are expressly described. Combinations or permutations of features described herein are covered by this disclosure.

This written description uses examples to disclose aspects of the disclosure, including the best mode, and also to enable any person skilled in the art to practice aspects of the disclosure, including making and using any devices or systems and performing any incorporated methods. While aspects of the disclosure have been specifically described in connection with certain specific details thereof, it is to be understood that this is by way of illustration and not of limitation. Reasonable variation and modification are possible within the scope of the forgoing disclosure and drawings without departing from the spirit of the disclosure, which is defined in the appended claims.

Further aspects of the disclosure are provided by the following clauses:

A treating chemistry distribution system for a plurality of treating chemistry devices wherein at least a portion of the treating chemistry distribution system is located within a structure defining at least one environment, the treating chemistry distribution system comprising a treating chemistry hub having a set of treating chemistry modules housing a plurality of treating chemistry reservoirs, a treating chemistry manifold having a set of supply lines independently fluidly coupling the plurality of treating chemistry reservoirs to the plurality of treating chemistry devices, and a water line fluidly having a water line inlet selectively coupled to a water supply and a first water supply line outlet fluidly coupled to a first treating chemistry device of the plurality of treating chemistry devices wherein at least a first supply line of the set of supply lines is fluidly coupled to the water line and the first supply line of the set of supply lines is configured to provide a treating chemistry from at least one treating chemistry reservoir of the plurality of treating chemistry reservoirs to the first treating chemistry device via the water line.

The treating chemistry distribution system of any preceding clause, further comprising a pressure reducer valve provided along a portion of the water line upstream of a location where the first supply line of the set of supply lines is fluidly coupled to the water line.

The treating chemistry distribution system of any preceding clause, further comprising a set of check valves located along each of the set of supply lines and wherein the set of check valves biased to prevent a flow of fluid from the water line and into the set of supply lines.

The treating chemistry distribution system of any preceding clause, further comprising a set of distribution valves located downstream of a location where the first supply line of the set of supply lines is fluidly coupled to the water line.

The treating chemistry distribution system of any preceding clause, wherein the water input includes at least one of a cold water input or a hot water input.

The treating chemistry distribution system of any preceding clause, wherein the treating chemistry manifold further comprises a plurality of treating chemistry conduits, a respective one of the plurality of treating chemistry conduits directly fluidly coupled to a corresponding one of the plurality of treating chemistry reservoirs, and a set of flow controllers selectively, a respective one of the set of flow controllers fluidly coupling a corresponding one of the plurality of treating chemistry conduits to a respective one of the set of supply lines, wherein the plurality of treating chemistry conduits define respective fluid inputs to the set of flow controllers and the set of supply lines define respective fluid outputs from the set of flow controllers.

The treating chemistry distribution system of any preceding clause, wherein at least one flow controller of the set of flow controllers has a first number of fluid inputs and a second number of fluid outputs and the first number is different from the second number.

The treating chemistry distribution system of any preceding clause, wherein the set of treating chemistry modules are defined by a set of bodies, with each body of the set of bodies defining an interior housing a respective portion of the plurality of treating chemistry reservoirs.

The treating chemistry distribution system of any preceding clause, wherein at least one body of the set of bodies includes a housing closure providing selective access to the interior of the at least one body.

The treating chemistry distribution system of any preceding clause, wherein the housing closure is a drawer.

The treating chemistry distribution system of any preceding clause, wherein the set of treating chemistry modules includes a plurality of treating chemistry modules, with each treating chemistry module of the set of treating chemistry modules housing a subset of treating chemistry reservoirs of the plurality of treating chemistry reservoirs.

The treating chemistry distribution system of any preceding clause, wherein the plurality of treating chemistry modules are stacked vertically.

The treating chemistry distribution system of any preceding clause, further comprising a set of treating chemistry cartridges, with each treating chemistry cartridge of the set of treating chemistry cartridges containing at least one treating chemistry reservoir of the plurality of treating chemistry reservoirs.

The treating chemistry distribution system of any preceding clause, wherein the set of treating chemistry cartridges are removable from the treating chemistry hub.

The treating chemistry distribution system of any preceding clause, wherein at least one treating chemistry cartridge of the set of treating chemistry cartridges holds two or more treating chemistry reservoirs of the plurality of treating chemistry reservoirs.

The treating chemistry distribution system of any preceding clause, wherein at least one treating cartridge of the set of treating cartridges is a refillable cartridge.

The treating chemistry distribution system of any preceding clause, further comprising a set of receivers, with the set of treating chemistry cartridges being receivable within the set of receivers.

The treating chemistry distribution system of any preceding clause, further comprising a housing closure providing selective access to an interior of the treating chemistry hub, with the set of receivers being located along the housing closure.

The treating chemistry distribution system of any preceding clause, wherein the housing closure is a drawer.

The treating chemistry distribution system of any preceding clause, wherein the plurality of treating chemistry devices are selected from a group of: a dishwasher, a laundry treating appliance, a garbage disposal, an oven, a range, and a microwave.

The treating chemistry distribution system of any preceding clause, wherein the plurality of treating chemistry devices include at least one of a soap dispenser, a faucet, or a refillable cartridge dispenser.

The treating chemistry distribution system of any preceding clause, wherein the plurality of treating chemistry reservoirs each hold a respective chemistry, with the respective chemistry being at least one of a soap, a detergent, a cleaning solution, a cleaning concentrate, or water treating fluid.

The treating chemistry distribution system of any preceding clause, wherein the at least one environment includes a first environment and a second environment separate from the first environment, and the treating chemistry hub is located in the first environment and at least one treating chemistry device of the plurality of treating chemistry devices is located within the second environment.

The treating chemistry distribution system of any preceding clause, wherein the first environment is a first room of the singular structure and the second environment is a second room of the structure.

A method of supplying a flow of chemistry from a treating chemistry distribution system and to a treating chemistry device, the treating chemistry distribution system comprising a treating chemistry hub having a set of treating chemistry modules housing a plurality of treating chemistry reservoirs, and a treating chemistry manifold independently having a set of supply lines fluidly coupling at least a portion of the plurality of treating chemistry reservoirs to the treating chemistry device, the method comprising determining, via the treating chemistry distribution system, an operational state of the treating chemistry device, and fluidly coupling, based on the operational state of the treating chemistry device, at least a portion of the plurality of treating chemistry reservoirs to the treating chemistry device through the treating chemistry manifold.

The method of any preceding clause, further comprising detecting, via the treating chemistry distribution system, a fill level of each treating chemistry reservoir of the plurality of treating chemistry reservoirs.

The method of any preceding clause, further comprising generating an alert if the fill level of at least one treating chemistry reservoir of the plurality of treating chemistry reservoirs falls below a threshold value of the fill level.

The method of any preceding clause, wherein the alert is at least one of a physical transmission, a visual transmission, an audible transmission, or a transmission sent to an electronic device.

The method of any preceding clause, further comprising receiving, at the treating chemistry distribution system, a signal from the treating chemistry device indicating an inadequate supply of treating chemistry.

The method of any preceding clause, further comprising detecting, via the treating chemistry distribution system, that a respective treating chemistry reservoir of the plurality of treating chemistry reservoirs falls below the threshold value of the fill level, and in response to detecting that the respective treating chemistry reservoir is below the threshold value of the fill level, automatically ordering, via the treating chemistry distribution system, treating chemistry to one of refill or replace the treating chemistry within the respective treating chemistry reservoir.

The method of any preceding clause, further comprising fluidly coupling a first flow of treating chemistry from a first treating chemistry reservoir of the plurality of treating chemistry reservoirs during a first operational state of the treating chemistry device, and fluidly coupling a second flow of treating chemistry from a second treating chemistry reservoir of the plurality of treating chemistry reservoirs during a second operational state of the treating chemistry device.

The method of any preceding clause, wherein the treating chemistry device is included in a plurality of treating chemistry devices, the method further comprising fluidly coupling, at a first time and based on the operational state of a first treating chemistry device of the plurality of treating chemistry devices, the flow of treating chemistry from at least one treating chemistry reservoir of the plurality of treating chemistry reservoirs to the first treating chemistry device, and fluidly coupling, at a second time and based on the operational state of a second treating chemistry device of the plurality of treating chemistry devices, the flow of treating chemistry from at least one treating chemistry reservoir of the plurality of treating chemistry reservoirs to the second treating chemistry device.

The method of any preceding clause, wherein the first time is different from the second time.

The method of any preceding clause, wherein the first time is at the same time as the second time.

The method of any preceding clause, further comprising selectively fluidly coupling, via at least one flow controller, the first flow of treating chemistry and the second flow of treating chemistry to a first supply line and a second supply line, respectively, leading to the first treating chemistry device and the second treating chemistry device, respectively.

The method of any preceding clause, wherein the at least one flow controller is a singular flow controller.

The method of any preceding clause, further comprising automatically fluidly coupling, via a controller module of the treating chemistry distribution system, the flow of treating chemistry to the treating chemistry device.

The method of any preceding clause, further comprising fluidly coupling the flow of treating chemistry to a supply line of the treating chemistry device, the supply line being configured as a water line.

The method of any preceding clause, wherein the treating chemistry device is located in a first environment, and the plurality of treating chemistry reservoirs are located in a second environment, different from the first environment.

What is claimed is:

1. A treating chemistry distribution system for a plurality of treating chemistry devices wherein at least a portion of the treating chemistry distribution system is located within a structure defining at least one environment, the treating chemistry distribution system comprising:
a treating chemistry hub having a set of treating chemistry modules housing a plurality of treating chemistry reservoirs;
a treating chemistry manifold having a set of supply lines independently fluidly coupling the plurality of treating chemistry reservoirs to the plurality of treating chemistry devices; and
a water line fluidly having a water line inlet selectively coupled to a water supply and a first water supply line outlet fluidly coupled to a first treating chemistry device of the plurality of treating chemistry devices;
wherein at least a first supply line of the set of supply lines is fluidly coupled to the water line and the first supply line of the set of supply lines is configured to provide a treating chemistry from at least one treating chemistry reservoir of the plurality of treating chemistry reservoirs to the first treating chemistry device via the water line.

2. The treating chemistry distribution system of claim 1, further comprising a pressure reducer valve provided along a portion of the water line upstream of a location where the first supply line of the set of supply lines is fluidly coupled to the water line.

3. The treating chemistry distribution system of claim 1, further comprising a set of check valves located along each of the set of supply lines and wherein the set of check valves biased to prevent a flow of fluid from the water line and into the set of supply lines.

4. The treating chemistry distribution system of claim 1, further comprising a set of distribution valves located downstream of a location where the first supply line of the set of supply lines is fluidly coupled to the water line.

5. The treating chemistry distribution system of claim 1, wherein the water input includes at least one of a cold water input or a hot water input.

6. The treating chemistry distribution system of claim 1, wherein the treating chemistry manifold further comprises:
a plurality of treating chemistry conduits, a respective one of the plurality of treating chemistry conduits directly fluidly coupled to a corresponding one of the plurality of treating chemistry reservoirs; and
a set of flow controllers selectively, a respective one of the set of flow controllers fluidly coupling a corresponding one of the plurality of treating chemistry conduits to a respective one of the set of supply lines, wherein the plurality of treating chemistry conduits define respective fluid inputs to the set of flow controllers and the set of supply lines define respective fluid outputs from the set of flow controllers.

7. The treating chemistry distribution system of claim 6, wherein at least one flow controller of the set of flow controllers has a first number of fluid inputs and a second number of fluid outputs and the first number is different from the second number.

8. The treating chemistry distribution system of claim 1, wherein the set of treating chemistry modules are defined by a set of bodies, with each body of the set of bodies defining an interior housing a respective portion of the plurality of treating chemistry reservoirs.

9. The treating chemistry distribution system of claim 8, wherein at least one body of the set of bodies includes a housing closure providing selective access to the interior of the at least one body.

10. The treating chemistry distribution system of claim 9, wherein the housing closure is a drawer.

11. The treating chemistry distribution system of claim 1, wherein the set of treating chemistry modules includes a plurality of treating chemistry modules, with each treating chemistry module of the set of treating chemistry modules housing a subset of treating chemistry reservoirs of the plurality of treating chemistry reservoirs.

12. The treating chemistry distribution system of claim 11, wherein the plurality of treating chemistry modules are stacked vertically.

13. The treating chemistry distribution system of claim 1, further comprising a set of treating chemistry cartridges, with each treating chemistry cartridge of the set of treating chemistry cartridges containing at least one treating chemistry reservoir of the plurality of treating chemistry reservoirs.

14. The treating chemistry distribution system of claim 13, wherein the set of treating chemistry cartridges are removable from the treating chemistry hub.

15. The treating chemistry distribution system of claim 13, wherein at least one treating chemistry cartridge of the set of treating chemistry cartridges holds two or more treating chemistry reservoirs of the plurality of treating chemistry reservoirs.

16. The treating chemistry distribution system of claim 13, wherein at least one treating cartridge of the set of treating cartridges is a refillable cartridge.

17. The treating chemistry distribution system of claim 13, further comprising a set of receivers, with the set of treating chemistry cartridges being receivable within the set of receivers.

18. The treating chemistry distribution system of claim 17, further comprising a housing closure providing selective access to an interior of the treating chemistry hub, with the set of receivers being located along the housing closure.

19. The treating chemistry distribution system of claim 18, wherein the housing closure is a drawer.

20. The treating chemistry distribution system of claim 1, wherein the plurality of treating chemistry devices are selected from a group of: a dishwasher, a laundry treating appliance, a garbage disposal, an oven, a range, and a microwave.
